(19) United States
(12) Patent Application Publication
(10) Pub. No.: US 2026/0245919 A1
(43) Pub. Date: Aug. 20, 2026

(54) A FUEL CELL

(71) Applicant: BRAMBLE ENERGY LIMITED, Crawley (GB)

(72) Inventors: Thomas James Mason, Crowborough (GB); Erik Charles ENGEBRETSEN, London (GB); Matthew Derek Richard Kok, London (GB); Simon Philip Jones, London (GB)

(21) Appl. No.: 19/469,524

(22) PCT Filed: Apr. 2, 2024
(86) PCT No.: PCT/GB2024/050895

§ 371 Date: Sep. 26, 2025

(30) Foreign Application Priority Data
Mar. 29, 2023 (GB) 2304664.2

(51) Int. Cl. H01M 8/0267; H01M 8/0202; H01M 8/0258; H01M 8/10; H01M 8/1004

(52) U.S. Cl. CPC H01M 8/0267; H01M 8/0258; H01M 8/0269; H01M 8/1004; H01M 2008/1095

(57) ABSTRACT

The present disclosure provides a fuel cell comprising at least one fuel cell board 200, 201. Each fuel cell board 200, 201 comprises a Membrane Electrode Assembly (MEA) 113 comprising at least one ion permeable membrane, at least one anode, and at least one cathode, wherein the one or more anodes are arranged on a first surface of the ion permeable membrane and the one or more cathodes are arranged on a second surface of the ion permeable membrane. Each fuel cell board 200, 201 also comprises a first insulating layer comprising at least one first fluid path 101 and a second insulating layer 102 comprising at least one second fluid path. The MEA 113 is located between the first insulating layer 101 and the second insulating layer 102 so that the at least one first fluid path is arranged such that an oxidant fluid can flow to one or more of the cathodes of the at least one fuel cell board and so that the at least one second fluid path is arranged such that a reductant fluid can fluid flow to one or more of the anodes of the at least one fuel cell board. The fuel cell board comprises at least one third fluid path for a heat exchange fluid 302.

The present disclosure relates to fuel cells, uses of fuel cells, components for fuel cells, components for electrochemical devices and methods of thermally managing fuel cells.

### BACKGROUND

A fuel cell (e.g. a solid-polymer-electrolyte fuel cell) is an electrochemical device which generates electrical energy and heat from a reactant or oxidant (e.g. pure oxygen or air) and a fuel (e.g. hydrogen or a hydrogen-containing mixture, or a hydrocarbon or hydrocarbon derivative). Fuel cell technology finds application in stationary and mobile applications, such as power stations, vehicles and laptop computers.

Typically, a fuel cell comprises two electrodes, an anode and a cathode, separated by an electrolyte membrane that allows ions (e.g. hydrogen ions), but not free electrons, to pass through from one electrode to the other. A catalyst on the electrodes accelerates a reaction with the fuel on the anode to separate electrons and protons/cations, and oxidant on the cathode to undergo a reduction reaction to water. A circuit can then be formed between the anode and the cathode generate a current to power e.g. an electrical device. A reactant fluid, e.g. oxygen or reactant air, is supplied to the cathode and a fuel, e.g. hydrogen, is supplied to the anodes.

A single pair of electrodes separated by an electrolyte membrane is called a membrane electrode assembly (MEA). A fuel cell MEA operating under a moderate load produces an output voltage of about 0.7V, which is often too low for many practical considerations. In order to increase this voltage, MEAs are typically assembled into a stack as shown in FIG. 1. Each MEA 1 has a layer of electrolyte membrane 1a (such as a Nafion™ membrane), which comprises an ion-permeable membrane sandwiched between two electrode layers, and an anode 2 and a cathode 3 on either side of the electrolyte membrane. Adjacent MEAs can be separated by an electrically conducting bipolar separator plate 4, and a fuel (e.g. hydrogen) 6 and an oxidant 5 (e.g. oxygen gas or ‘reactant air’) flow through the channels provided on opposing sides of the bipolar plate. End plates 9 are connected to an external circuit via an electrical connector 7, 8. The number of these MEAs in a stack in a fuel cell determines the total voltage, and the surface area of each membrane electrode determines the total current. Catalyst layers adjacent to the electrodes increase the rate of and efficiency of the reactions at the electrodes.

FIG. 2 shows an exemplary fuel cell of the prior art (see e.g. WO 2012/117035) in which a plurality of fuel cell boards 22 are stacked between two endplates 21 in order to provide increased voltage and power. Electrode pairs are arranged in a series along either side of a single layer of polymer electrolyte 10, such as a Nafion™ membrane. Anodes 11 are disposed on one surface of these membranes and cathodes 12, separated by gaps are disposed on the other, opposite, surface of these membranes. The anode and cathode respectively of two adjacent electrode pairs may partially overlap. Through-membrane electrical connectors 13 connect the electrodes across the membrane in the overlapping region, and may be produced by a homogeneous chemical deposition process. A catalyst layer adjacent to the electrodes encourages the reactions at the electrodes. A fuel 17, such as hydrogen gas, flows along the face of the fuel cell board 22 supplying the anodes 11 and a reactant or oxidant 16, such as oxygen gas or air, flows along the surface of the fuel cell board 22 supplying the cathodes 12. One electrode at the edge of the upper surface and one electrode at another edge of the lower surface of the fuel cell board are connected to an external circuit via an electrical connection 18, 19. In this series arrangement, the surface area of an electrode pair determines the size of the current for a fuel cell board 22, but the voltage accumulates in proportion to the number of electrode pairs on that fuel cell board 22.

Electrically insulating spacers 20 can be integrated into the stack between each of the fuel cell boards each comprising a spacer composed of electrically insulating material (such as plastic).

The size of an individual cell (the surface area of a pair of electrodes) determines the size of the current for a fuel cell board. The total number of individual cells on a fuel cell board determines the voltage produced. The number of fuel cell boards in a stack determines the size of the total current of the fuel cell stack.

The end cathodes and anodes 11 on each fuel cell board are connected to respective first and second output lines via electrical connections 18, 19. The connection between each fuel cell board in the stack and the second output line can be controlled by a switch mechanism such as a field-effect transistor (FET) switch providing power handling and control directly at the cell. Each of these switches can be controlled by individual control lines.

There are a number of factors that determine the performance of a fuel cell. Maintaining the correct water content in the electrolyte membrane is essential to optimising a fuel cell's performance. The membrane requires a certain level of moisture to operate and conduct the ionic current efficiently so that the fuel cell current does not drop. Water produced by the cell is removed by the flow of fluid along the cathode or wicked away.

Overheating of the fuel cell stack can also cause problems and cooling is often required. This is generally achieved by supplying a coolant fluid (e.g. air or water) that circulates within the stack. In addition, a reactant fluid (e.g. oxygen or reactant air) is required by the cathodes to maintain a reaction. Fuel cells can also be at a lower than optimum temperature (i.e. too cold) in certain situations, such as at start up or in low temperature environments.

Thus, fuel cell and fuel cell stack temperature management is important, and can be a limiting or defining factor in fuel cell performance. For example, fuel cells may be below the optimal operation temperature at start up, or for example fuel cells may rise above the optimal operation temperature during operation. Further, fuel cell temperature may be inconsistent throughout a fuel cell stack (temperature imbalances). Environmental factors may also play a part in the need to control the thermal properties of a fuel cell, for example different thermal management will be required in low temperature environments to high temperature environments.

Being able to manage or control the thermal properties of a fuel cell, e.g. heating or cooling of a fuel cell, is an important part of fuel cell operation. Fuel cells may require quick system reactions to temperature changes and efficiency improvements through thermal management will help to improve the performance of fuel cells.

Thermal control design must be balanced with the potentially limited space availability in fuel cells and the potential loss of efficiency and increased manufacture costs with complicated thermal control systems, e.g. cooling, systems. Fuel cell power and valuable space inside fuel cell boxes can be lost utilising heat pump or other such thermal management systems. It is often desirable to design fuel cells to be as compact or space efficient as possible, particularly in the stack of fuel cell boards within a fuel cell itself. Reducing the size of fuel cells and the size of the fuel cell stack particularly can be advantageous. In view of the foregoing, it is desirable to provide improved fuel cells, fuel cell stacks, fuel cell designs, components for fuel cells, improved means to manage the thermal properties of fuel cells and uses of these fuel cells to achieve improved fuel cell thermal management, whilst being cost effective and not adversely affecting the efficiency, affordability or size of the fuel cells. There is also a need to similarly improve components for other electrical chemical devices.

### SUMMARY

An aspect of the invention provides a fuel cell comprising at least one fuel cell board. Each fuel cell board or component for a fuel cell described herein may comprise a Membrane Electrode Assembly (MEA), the MEA comprising at least one ion permeable membrane, at least one anode, and at least one cathode, wherein one or more of the anodes are arranged on a first surface of the ion permeable membrane and one or more of the cathodes are arranged on a second surface of the ion permeable membrane, a first insulating layer comprising at least one first fluid path and a second insulating layer comprising at least one second fluid path. It may be that all of the anodes are arranged on one surface of an ion permeable membrane and it may be that all of the cathodes are arranged on one surface, the other surface, of an ion permeable membrane. The MEA is located between the first insulating layer and the second insulating layer so that the at least one first fluid path is arranged such that an oxidant fluid can flow to the one or more of the cathodes of the at least one fuel cell board and so that the at least one second fluid path is arranged such that a reductant fluid can fluid flow to the one or more of the anodes of the at least one fuel cell board. The fuel cell board further comprises at least one further or a third fluid path for a heat exchange fluid. The further/third fluid path for a heat exchange or thermal management fluid is a path or a channel in either of or both of the first and second insulating layers, or located in an additional (e.g. third) insulating layer of the fuel cell board, which can carry a thermal management fluid or a temperature control fluid, as described herein. This fluid path may be a ‘heat exchange fluid path’. This fluid can act to thermally manage or control the temperature or thermal properties of the fuel cell boards, fuel cells, components for fuel cells or fuel cell stacks described herein. Reference herein to ‘controlling’ the temperature means being able to increase or decrease the temperature by way of heat transfer in or out of the fluid/flow path.

The presently described inventions are of a modular nature, where fuel cell boards can be stacked. The modular nature allows an increased control over the design of the fuel cell stacks, allowing for easy customisation in size, shape, power and voltage-current characteristics of the fuel cells. Individual boards can be individually switchable or removable, causing a change in capacity. Fuel cells of varying design can easily be manufactured from the same components.

The insulating layers described herein can be printed circuit board (PCB) layers, as described herein. PCB boards comprising an insulating material, such as FR-4 epoxy resin boards with copper plating on one or more of the outside faces, have the advantage of enabling the elements to be manufactured in large quantities and at low cost. For example, multiple flow field boards can be manufactured at the same time, by using thin laminate boards which are stacked and then simultaneously routed or drilled. Individually routed boards are then stacked. PCBs have a high mechanical strength, whilst being light, and can be laminated together or mechanically pressed or compressed together to provide a solid structure (if desired), with good contact between the individual layers. A PCB insulating layer of the present invention may comprise multiple PCB layers, referred to as a single insulating layer. Accordingly, a monolithic, light, and completely sealed structure is produced. Use of insulating materials to construct such fuel cell also enables the present fuel cells, fuel cell boards and components to be constructed without a mass or size penalty which may be present using other materials such as metal. The herein described insulating material plates can be plated with a conductive material such as copper (e.g. PCB boards) and/or have conductive material plated or filled through holes or other means to conduct electrical current through or across the plates. This allows improved control of current through stacks, as not all of the plates, spacers etc need be conductive, like when prior art bipolar plates or conductive metal components are utilised in prior art stacks. Conductive features, such as through holes, e.g. copper plated or conductive resin filled though holes can be in specific areas to allow a high level of control of the current through or across fuel cell boards/fuel cell stacks.

The designs described herein integrate the heat exchange, thermal management or temperature control fluid pathways with the fuel cell boards themselves, offering further improvement over similar designs described before. Heat exchange fluid pathways integrated in the same layer the anode or cathode flow pathways has not been described before with the designs described herein. This reduces the number of layers in the fuel cell stack, as a separate thermal management, heat exchange or heat exchange plates may not be required, or coolant spacers for coolant, heat exchange or thermal management airflow may not be required. Fewer layers (i.e. fewer insulating or PCB layers) reduces the overall fuel cell board size and/or the fuel cell stack size, without reducing the possible power of the fuel cell stack. Fewer layers (i.e. fewer insulating or PCB layers) or thinner layers/boards increases the power density of the fuel cell board and/or fuel cell stack. The designs described herein can also offer an increased efficiency. The heat exchange fluid is separated from the oxidant fluid, these are different fluid flows.

The present fuel cells also allow increased packing density of fuel cell boards, due to the nature of the presently described fuel cell boards. Compressed and/or laminated fuel cell boards as described herein have an inherent seal created, removing the need for gaskets between different fuel cell boards to seal boards together, as are found in traditional fuel cell stacks (which do not comprise laminated insulating material boards). The seal is formed because the heat exchange fluid channels are located on or through the body of the insulating layers used to form the fuel cell boards, or because heat exchange plates are used between boards, sealing possible gaps between fuel cell boards that would otherwise inherently exist. This also results in electrical insulation of the boards in appropriate places.

A reduced stack size resulting in a potentially reduced fuel cell size or a reduced fuel cell weight may also offer advantages in applications where a smaller or lighter fuel cell size is required.

Such flow path or fuel cell board designs are not possible, or much harder to achieve, when making fuel cell boards out of materials other than the insulating materials, e.g. PCBs, described herein. Metal fuel cell boards are typically stamped to produce flow field designs, which results in the same flow pathway design on both sides of a metal board, but the channels on one side of the board will be a negative image of the channels on the other side of the stamped metal board. This makes it impossible to have the flexibility of design described herein, i.e. having different flow path geometry or design on two different faces or surfaces of the same layer of material. Particularly, as flow paths are stamped in metal plates there cannot be a height difference in flow paths for paths on opposite faces of the same metal plate. Thus, having the heat exchange fluid pathways as described here (interdigitated or having a different flow pathway within the same anode or cathode plates, or paths forming between plates) is not possible with standard metal plate design, the pathways must mirror, repeat or complement each other in a stamped manufacture process. In the designs described herein, the flow pathways on opposite faces of the same boards can have different pathways, e.g. different pathway heights, because the insulating materials, e.g. PCB material, described herein can be routed or milled to produce the flow pathways. The flow pathways on opposite faces of the same layers can be interdigitated with one another. The flow paths on different faces of the layers described herein can have a different depth or pathway to those on the other face of the same board. This is much easier and cheaper with the insulating materials, such as PCB, described herein compared to metal or other such fuel cell board manufacture materials, and is not possible in such metal or other material fuel cell board materials.

The heat exchange fluid may flow near or flow adjacent or flow to contact one or more portions of the fuel cell boards, fuel cells, components for fuel cells or fuel cell stacks described herein. For example, the systems and methods herein can allow a heat exchange or thermal management fluid to flow through a flow path adjacent or near the anodes of a fuel cell board, acting to cool those anodes. They may also act to warm or cool cathodes. They may also act to manage the temperature of adjacent fuel cell boards, for example the anodes or cathodes of adjacent fuel cell boards.

Thermal management, heat exchange or temperature control will act to maintain the fuel cell board or stack at a certain operating temperature, to operate the system in a more energy efficient manner, to increase the operating lifetime of the system, and/or to provide more efficient fuel cell operation (e.g. allowing a fuel cell to operate within set parameters, not leading to over production or under production of power).

Preferably, any of the herein described fluid flow paths can be formed within or on an insulating layer such that the fluid flow path is routed or grooved within or through part of the body of one or more faces of the layers. In other words, the fluid flow path is formed without the routing or groove extending all the way through the layer. This may be through one or more individual layers of insulating material that form the insulating layer. This may be through just the copper layer and any other layer present (e.g. a passivation layer, e.g. a passivation ink layer), and not through any layer of the insulating material itself. Preferably, any of the herein described fluid flow paths are in or on the surface of an insulating layer. As can be seen throughout some of the figures herein, a fluid flow path may provide a flow path for fluid within a single layer, as opposed to requiring one layer to provide a flow path, and another layer to provide a sealing face sealing the fluid path. Depth routing may be to a depth of up to 1 mm. Depth routing may be to a depth of up to 3 mm, 2 mm or 1 mm may be found. Depth routing of around 3 mm, 2 mm, 1 mm, 0.9 mm, 0.8 mm, 0.7 mm, 0.6 mm, 0.5 mm, 0.4 mm, 0.3 mm, 0.2 mm or 0.1 mm. Depth routing my be around between 3 mm and 0.1 mm, or around between 1 mm and 0.3 mm, or of around between 0.9 mm and 0.4 mm, or around between 0.8 mm and 0.4 mm may be found. Here depth routing can be used because it maintains the sealing integrity of any one individual layer. Flow paths may be formed by any technique known in the art, routing or any other technique which leads to layers with such flow paths. Preferably, depth routing is where the whole layer (e.g. PCB board) is not routed through, i.e. only 10%, or only 20%, or only 30%, or only 40%, or only 50%, or only 60%, or only 70%, or only 80%, or only 90% of the depth of the layer is routed through. Preferably only 10% to 90% of the depth of the layer is routed through, preferably only 20% to 80% of the depth of the layer is routing through, preferably only 50% to 75% of the depth of the layer is routing through. This may also be referred to as depth drilling or depth routing. Preferably at least 0.1 mm of layer remains below the routed or drilled area after depth drilling. Preferably between about 0.10 mm and 0.40 mm of layer remains below the routed or drilled area after depth drilling.

Preferably, any of the herein described fluid flow paths can be formed within or on an insulating layer such that the fluid flow path is routed or grooved through the whole body of one or more faces of the layers. In other words, the fluid flow path is formed by routing all the way through the layer. Some flow paths have a depth equal to or greater than (i.e. the depth of the layer and also additional components on or either side of the layer, for example a copper or passivation layer) an insulating layer. These may be described as full depth routed flow paths. Or routed 100% of the depth of the layer, or full depth drilling or routing.

Preferably, the one or more third/further heat exchange fluid pathway(s) is found only in the copper plating or copper layer and if present the passivation layer on an insulating layer. This may be on one or more of the first, second, third or further/other insulating layers. Preferably, depth routing is not through the insulating material of the insulating layer, i.e. not through the PCB core material e.g. FR-4, but through any other layers present external to the insulating core, for example the copper plating or copper layer and/or the passivation layer.

Preferably, one or more of the flow paths described herein is routed through the whole body of the layer. Preferably, one or more of the reactant fluid paths (e.g. the first or second fluid paths) are routed through the whole body of the layer.

Preferably, at least two of the layers of the fuel cell board are laminated together. Preferably, at least two of the layers of the fuel cell board are mechanically pressed or compressed together, preferably with a sealant, when in a fuel cell stack.

Preferably, the second insulating layer comprises the at least one further or a third fluid path for a heat exchange fluid. The at least one further/third fluid path is arranged so that the heat exchange fluid can control the thermal properties or control the temperature of the fuel cell board, preferably at least the thermal properties or the temperature of the at least one anode. Alternatively, or additionally, the first insulating layer comprises the at least one further or a third fluid path for a heat exchange fluid, or at least one additional/fourth fluid path for a heat exchange fluid. This may control the thermal properties or control the temperature of the fuel cell board, preferably at least the thermal properties or the temperature of the at least one anode of an adjacent fuel cell board.

The heat exchange fluid is separated from the oxidant fluid, these are different fluid flows.

Preferably, the fuel cell comprises a plurality of the fuel cell boards. Preferably, each of the plurality of fuel cell boards may be arranged such that the first insulating layer and the one or more cathodes of each fuel cell board face the second insulating layer and the one or more anodes of an adjacent fuel cell board. Each of the plurality of fuel cell boards may be arranged such that the second insulating layer and the one or more anodes of each fuel cell board face the first insulating layer and the one or more cathodes of an adjacent fuel cell board.

Preferably, the first layer further comprises the at least one further or a third fluid path for a heat exchange fluid, the at least one further/third fluid path arranged so that the heat exchange fluid can control the thermal properties or control the temperature of the fuel cell board and/or control the thermal properties or control the temperature of at least one of the adjacent fuel cell boards. Preferably the heat exchange fluid can control the thermal properties or the temperature of at least one anode of an adjacent fuel cell board.

Preferably, the at least one further/third fluid path is on the opposite face of the insulating layer to the at least one first fluid path or the at least one second fluid path on the same insulating layer. Preferably, the at least one further/third fluid path is arranged on the opposite face of the insulating layer so there is no overlap in fluid path through the insulating layer of the at least one further/third fluid path with the path of the other fluid path on the same insulating layer (the at least one first fluid path or the at least one second fluid path, whichever one is present on the layer with the third path, or both if both layers have a heat exchange fluid path). The at least one further/third fluid path is arranged on the opposite face of the insulating layer so there is no overlap in fluid path through the insulating layer of the at least one further/third fluid path with the path of the at least one first fluid path or the at least one second fluid path on the same insulating layer.

Preferably, there is no overlap in the fluid paths so that the fluid paths never cross pathways. They may never cross pathways in that they never touch. Or they may never cross pathways through the body in the insulating layer such that each path never traverses the layer in the space (vertically) above the other flow path. The pathway of the at least one further/third fluid path does not cross the pathway of the other fluid path on the same layer. The surface area of the face of the insulating layer covered by the at least one further/third fluid path is different to surface area of the face of the insulating layer covered by the other fluid path on the opposite face of the insulating layer (the first fluid path or the path of the second fluid path).

Preferably, wherein when the further/third fluid path is on the first insulating layer the sum of the depth of: i) the at least one first fluid path; and ii) the further/third fluid path, is equal to or greater than the thickness of the first insulating layer. Preferably, wherein when the further/third fluid path is on the second insulating layer the sum of the depth of: i) the at least one second fluid path; and ii) the further/third fluid path, is equal to or greater than the thickness of the second insulating layer. When both the first insulating layer and the second insulating layer comprise a third/further fluid path for heat exchange fluid, then both of these may happen. This may be referred to herein as interdigitated of the channels. The channels run adjacent to each other, but never touch or cross paths. This is preferably when the channels are on opposite faces of the same insulating layer. The thickness of the layer is the distance between the two faces of the layer which the at least two channels are found on.

When there are multiple channels it is preferably that wherein the sum of the depth of: i) one of the at least one first fluid path or one of the at least one second fluid path and ii) one of the further/third fluid path, is equal to or greater than the thickness of whichever of the first insulating layer or the second insulating layer comprises the further/third fluid path. Or it may be the average of the depths of the fluid channels, not only one of.

Preferably, fluid flow paths may not cross with or overlap an axis (or one or more axes) defined by the top or bottom of another flow path on/in the same insulating board which is on the opposite face of the same insulating board, wherein this axis is parallel to the two surfaces of the insulating board in which these two or more flow paths are found. These flow paths would be considered integrated on/in the same board, but not interdigitated with each other.

Preferably, fluid flow paths may not cross with or overlap an axis defined by a vertical edge of another flow path which is on/in the same insulating board but on the opposite face of the same insulating board, wherein these axes are orthogonal to an axis parallel to the two surfaces of the insulating board in which these two or more flow paths are found. These flow paths would be considered integrated on the same board, and may be interdigitated with each other. When interdigitated with each other, the fluid flow paths may cross with or overlap a second axis defined by the top or bottom of the another flow path on/in the same insulating board which is on the opposite face of the same insulating board, wherein this second axis is parallel to the two surfaces of the insulating board on/in which these two or more flow paths are found. These flow paths would be considered integrated on the same board, and also interdigitated with each other.

When the sum of the channel depths is greater than the thickness of the layer then the bottom of or the depth of the first fluid path is lower or less than the height or the top of the second fluid path (through the body of the insulating layer), or the height or top of the second fluid path is higher or greater then than the bottom of or the depth of the first fluid path. When there are multiple channels it is preferably that the bottom of or the depth of one of the first fluid path is lower or less than the height or the top of one of the second fluid path (through the body of the insulating layer), or the height or top of one of the second fluid path is higher or greater then than the bottom of or the depth of one of the first fluid path. Or it may be the average of the depths of the fluid channels, not only one of.

Preferably, the depth of the at least one further/third fluid path is equal to or equal to or than the thickness of whichever of the first insulating layer or the second insulating layer comprises the further/third fluid path. Preferably, wherein when the first insulating layer further comprises the at least one further/third fluid path, the depth of the at least one first fluid path is also greater than the thickness of the first insulating layer. Additionally, or alternatively, when the second insulating layer further comprises the at least one further/third fluid path, the depth of the at least one second fluid path may also be equal to or greater than the thickness of the first insulating layer. Here one or more of the fluid channels goes through the body of the insulating layer. This means that the fluid channel/flow path/channel is open to both faces or surfaces of the insulating layer. Additional layers of insulating material or additional insulating layers may be added to seal or cap one or more of these channels, as described herein.

Preferably, the first insulating layer comprises a copper layer on the opposite side of the first insulating layer to the side facing the cathodes. Preferably, the first insulating layer may also comprise a passivation layer on the copper layer. The at least one third fluid path may be in the copper and/or in the passivation layer on the first insulating layer. Preferably, the second insulating layer comprises a copper layer on the opposite side of the second insulating layer to the side facing the anodes. Preferably, the second insulating layer also comprises a passivation layer on the copper layer. The at least one third fluid path may be in the copper and/or in the passivation layer on the second insulating layer. Preferably, the fuel cell board comprises a plurality of fuel cell boards and at least two of the plurality of fuel cell boards are arranged so that at least one heat exchange fluid path is formed between two fuel cell boards when adjacent boards are aligned with each other. The at least one third fluid path in the copper and/or in the passivation layer on an insulating layer of one fuel cell board and the at least one third fluid path in the copper and/or in the passivation layer on an insulating layer of another adjacent fuel cell board align with each other so as to form the at least one heat exchange fluid path between the two adjacent fuel cell boards (a combined heat exchange fluid path between the two fuel cell boards). When found in the copper/passivation layer, the flow path may be open when viewed in isolation as a single layer.

Fluid paths formed between two fuel cell boards may be referred to as negative space paths, where the heat exchange pathway is formed in the negative space between two or more fuel cell boards. These may offer space saving over other arrangements, because the channels are formed in the copper (and if present a passivation layer) layers between two boards, rather than in the core layers themselves. The overall assembly of the layers in the fuel cell boards may be thinner as a result of this. The adjacent fuel cell boards may be aligned so that the heat exchange fluid paths align and form combined/joint heat exchange fluid paths.

Preferably, the fuel cell board comprises at least one third/further insulating layer. When the first insulating layer comprises the at least one third/further fluid path the third/further insulating layer can be located on or adjacent to the face of the first insulating layer which comprises the third/further fluid path so as to seal the at least one further/third fluid path. Preferably the depth of the first fluid path is equal to or greater than the thickness of the first insulating layer and the third insulating layer also seals the side of the at least one first fluid path not adjacent the cathodes. When the second insulating layer comprises the third/further fluid path the third/further insulating layer can be located on or adjacent to the face of the second insulating layer which comprises the third/further fluid path so as to seal the at least one further/third fluid path. Preferably, the depth of the second fluid path may be equal to or greater than the thickness of the second insulating layer and the third insulating layer may also seal the side of the at least one second fluid path not adjacent the anodes.

Preferably, when the depth of the first fluid path is equal to or greater than the thickness of the first insulating layer, or the depth of the second fluid path is equal to or greater than the thickness of the second insulating layer, the third insulating layer seals the side of the first fluid path not facing the cathodes and/or seals the side of the second fluid path not facing the anodes.

Preferably, when the depth of the first fluid path is equal to or greater than the thickness of the first insulating layer, or the depth of the second fluid path is equal to or greater than the thickness of the second insulating layer, the third insulating layer seals the side of the first fluid path not facing the cathodes or seals the side of the second fluid path not facing the anodes and a further/fourth insulating layer seals the side of the first fluid path not facing the cathodes or seals the side of the second fluid path not facing the anodes. Here, there are multiple capping layers, two per fuel cell board, to seal both sides of the fuel cell board so that the first and second fluid paths are sealed or capped.

Preferably, when the third and/or fourth insulating layers seal the first and/or second fluid paths, the third and/or fourth insulating layer may comprise a copper layer on the opposite side of the third or fourth insulating layer to the side sealing first and/or second fluid path. The third and/or fourth insulating layer may also comprise a passivation layer on the copper layer. Preferably, the at least one third fluid path is in this copper and/or in this passivation layer on the first insulating layer. Preferably, the fuel cell comprises a plurality of fuel cell boards, wherein at least two of the plurality of fuel cell boards are arranged so that at least one heat exchange fluid path is formed between two adjacent fuel cell boards when aligned with each other, wherein the at least one third fluid path formed in the copper and/or in the passivation layer on the third or fourth insulating layer of one fuel cell board and the at least one third fluid path formed in the copper and/or in the passivation layer on the third or fourth insulating layer of another adjacent fuel cell board aligned with the other so as to form a combined heat exchange fluid path between the two fuel cell boards. Preferably, when the third insulating layer and/or the further/fourth insulating layer comprise the at least one third fluid path for a heat exchange fluid, the depth of the at least one third fluid path for a heat exchange fluid can be equal to or greater than the thickness of the third and/or fourth insulating layer. The adjacent fuel cell boards may be aligned so that the heat exchange fluid paths align and form combined/joint heat exchange fluid paths.

Preferably, both the first insulating layer and the second insulating layer have a further insulating layer (third and fourth insulating layers) capping/sealing the first and second fluid paths, and the first and second fluid paths are equal to or greater than the thickness of the first and second insulating layer. Preferably, both the third and fourth insulating layers comprise heat exchange fluid paths (third and fourth fluid paths). Preferably the heat exchange fluid path in each of the third and fourth insulating layers is equal to or greater than the thickness of the respective insulating layer. Or preferably, the heat exchange fluid paths are formed in a copper layer (and optionally a passivation layer) on each of the third and fourth insulating layers. When these boards are adjacent to other fuel cell boards with heat exchange fluid paths in the copper/passivation layer the adjacent boards may align with each other so as to form a combined heat exchange fluid path between the two fuel cell boards.

The negative space fluid paths are as described above. Combined with first and/or second flow channels which go through the whole body of the first and/or second insulating layers, there are further space saving advantages to these embodiments. The first and second layers may be thinner as a result of this, and the heat exchange pathways can be located in the negative space between fuel cell boards, for a more space efficient fuel cell stack.

The third/further insulating layer may be thinner than the first or second insulating layer. This third/further insulating layer may be described as a capping layer. This acts to “cap” or seal the flow paths which it is adjacent to. Here it would be adjacent to the at least one further/third fluid path, or a first or second fluid path, and would act to seal this path. Preferably, the third/further insulating layer is laminated to the fuel cell board, or mechanically compressed in the fuel cell stack. The one or more fluid paths sealed by this further/third insulating layer will be sealed so that any fluid flowing through these paths will only flow along/through the paths, along the intended path, and nowhere else. The third layer for any of the embodiments described herein may be referred to as a cap layer.

Preferably, the at least one third/further insulating layer is located over or one or more of the at least one the third/further fluid path so as to cover, cap or seal the one or more third/further fluid paths. Preferably, the at least one third/further insulating layer is located over multiple of the third/further fluid paths so as to cover, cap or seal the multiple third/further fluid paths.

Preferably, the fuel cell board may comprise multiple third/further insulating layers, adjacent to multiple fluid flow paths on the fuel cell board, to cap or seal multiple flow paths of the fuel cell board. These may preferably all be third/further fluid flow paths for heat exchange fluid, but may cover other fluid paths too.

Preferably, one or more of the third/further insulating layers is substantially the same size or a suitable size (i.e. width, dimensions) as the first or second insulating layer, so it covers substantially all of the first or second insulating layer. Preferably, one or more of the third/further insulating layers is substantially the same size as the area of the first or second insulating layer which comprises the one or third/further fluid flow paths so as to cover all of the third/further fluid flow paths.

Preferably, at least one of the first fluid path, the second fluid path or the third/further fluid path is substantially linear. Preferably, at least one of the first fluid path, the second fluid path or the third/further fluid path is serpentine.

Preferably, the fuel cell board comprises multiple first fluid paths and/or multiple second fluid paths and/or multiple third/further fluid paths. Preferably, the fuel cell board comprising at least one of the following: multiple first fluid paths which are substantially linear and substantially parallel with each other, multiple second fluid paths which are substantially linear and substantially parallel with each other and/or multiple third/further fluid paths which are substantially linear and substantially parallel with each other.

Preferably, any one of the first, second, third, fourth or further fluid paths may be open on one or both sides of an insulating layer. Preferably, any one of the first, second, third, fourth or further fluid paths may be not covered, or open channels.

Preferably, the at least one further/third fluid path has a different flow path pattern or flow field to the at least one first fluid path or the at least one second fluid path. For example, one of the paths may be substantially linear and the other may be serpentine.

Preferably there are more of one of the multiple first fluid paths and/or multiple second fluid paths and/or multiple third/further fluid paths than the other fluid paths, for example there may be more third/further fluid paths than the first fluid paths.

Preferably, one or more of the insulating layers comprise one or more PCB boards. Preferably the one or more PCB boards comprise FR-4 layers, also known as FR-4 epoxy resin, polyimide and/or other polymeric materials. PCB board comprise an insulating material, such as FR-4 epoxy resin, with copper or conductive material plating on one or more of the outside faces. Preferably the one or more insulating layers comprises at least some electrically conducting material (for example copper, at least partially copper coated) on (covering, layered or plated) at least part of one face or surface of the insulating layer(s), i.e. a layer of copper, or has at least some electrically conducting material on (covering, layered or plated) at least part of both faces or surfaces of the insulating layer. Preferably, those at least partially electrically conducting material covered or plated faces or surfaces are the same faces or surfaces of the insulating layer which comprise the first, second or third/further fluid flow paths described herein. Preferably, those at least partially electrically conducting material covered or plated surfaces or faces are the same surfaces or faces of the insulating layer(s) which are adjacent the anodes or cathodes, and the electrically conducting material can act to carry electrical current to or away from the anodes and/or the cathodes. Preferably, the electrically conducting material may also act to carry electrical current to or away from conductive through holes, e.g. conductive material plated through holes or conductive material filled through holes, which may be formed through the body of the insulating layer(s). The at least some electrically conducting material may also act to carry electrical current to or away from adjacent fuel cell boards or other components of the fuel cell. Preferably, there may be multiple layers of insulating material to form a single layer, e.g. multiple PCB board layers, possibly with electrically conducting just on one or more of the outside layers of these multiple layers.

Preferably, at least one of the first insulating layer, the second insulating layer and/or the third/further insulating layer comprises one or more means to conduct electrical current from one surface of or face of the insulating layer to the other, opposite, surface of or face of the (first, second and/or third/further) insulating layer. Preferably the means to conduct electrical current are plated through holes. Preferably the plated through holes are copper plated through holes. Preferably, those surfaces or faces of the insulating layer which comprise these means also comprise the first, second or third/further fluid flow paths described herein. Preferably, the one or more means to conduct electrical current from one surface of or face of the insulating layer to the other surface of or face of the (first, second and/or third/further) insulating layer are on the same surfaces or faces of the insulating material layers(s) which are adjacent the anodes or cathodes, and the means (for example copper plated through holes) can act to carry electrical current to or away from the anodes and/or the cathodes. Preferably, the means may conduct electrical current to or from copper plating on the insulating layer, which may also be acting to carry electrical current to or away from the anodes and/or the cathodes. The means to conduct electrical current described here may also act to carry electrical current to or away from adjacent fuel cell boards or other components of the fuel cell.

Preferably, the heat exchange fluid comprises water or a mixture of water and glycol, preferably wherein the water is deionised water. The water may or may not be deionised water, dependent on the application. Preferably the heat exchange fluid is fluid with a ratio of 1:1 (deionised) water to glycol (such as ethylene glycol or propylene glycol), or a ratio of 2:1 deionised water to glycol, or a ratio of 3:1 deionised water to glycol, or a ratio of 4:1 deionised water to glycol, or a ratio of 5:1 deionised water to glycol. The heat exchange fluid may be up to 10% glycol in (deionised) water, or 1% glycol in deionised water, or 2% glycol in deionised water, or 5% glycol in deionised water, or 10% glycol in deionised water, or 20% glycol in deionised water, or 30% glycol in deionised water, or 40% glycol in deionised water, or 50% glycol in deionised water. The heat exchange fluid may be a mixture of another type of alcohol (for example, methanol, ethanol, isopropyl alcohol) and deionised water. A solution may be up to 10% alcohol in deionised water, or 1% alcohol in deionised water, or 2% alcohol in deionised water, or 5% alcohol in deionised water, or 10% alcohol in deionised water, or 20% alcohol in deionised water, or 30% alcohol in deionised water, or 40% alcohol in deionised water, or 50% alcohol in deionised water. Coolant fluid may also comprise one or more perfluoroamines, such as Fluorinert. Any water described as deionised throughout may also cover non-deionised water, and vice versa.

Preferably, the fuel cell comprises the heat exchange fluid in at least the third fluid path. The heat exchange fluid may be present in the fuel cell as described herein, preferably present in the one or more the third fluid paths for the heat exchange fluid.

Preferably, the or each fuel cell board comprises a plurality of anodes and a plurality of cathodes, wherein the anodes and cathodes are arranged in pairs opposite each other across the ion permeable membrane. Preferably, in a single fuel cell board all of the anodes are on the same side of the ion permeable membrane and all cathodes are on the other side of the same ion permeable membrane. Preferably, each fuel cell board only comprises one anode and/or each fuel cell board only comprises one cathode.

Preferably, the fuel cell further comprises further means to control the temperature of the at least one fuel cell board or adjacent fuel cell boards. The means to control the temperature of the at least one fuel cell board comprises at least one further insulating layer, the further insulating layer comprising at least one further/fourth fluid path for a heat exchange fluid. This at least one further insulating layer is arranged between the first insulating layer of the fuel cell board and the second insulating layer of an adjacent fuel cell board. This at least one further insulating layer comprises means to conduct electrical current from one face of the at least one further insulating layer to the other face of the at least one further insulating layer. This may allow it to act as a bipolar plate. This may enable electrical contact of anodes and cathodes of adjacent fuel cell boards, as described herein. The heat exchange insulating layer may be laminated to the first or the second insulating layer of the fuel cell board. Preferably, this further means laminated to the second insulating layer, i.e. adjacent to the anode side of the MEA. Lamination of the further means to the fuel cell board allows increased energy density because in this further means there may be just one further layer, as opposed to multiple layer means or thicker means as described previously. Further, sealing the further means plate to the fuel cell board simplifies assembly of the fuel cell stacks, due to there being fewer components and fewer non-built-in seals to the stack. Preferably, this further/fourth fluid path carries a coolant fluid to cool the fuel cell board or an adjacent fuel cell board. Preferably this heat exchange fluid is the same as the heat exchange fluid in the third/further fluid path located in/on the first insulating layer and/or located in/on the second insulating layer. Preferably this heat exchange fluid is different to the heat exchange fluid in the third/further fluid path located in/on the first insulating layer and/or located in/on the second insulating layer. This further means to control the temperature of the at least one fuel cell board or adjacent fuel cell board may be present when neither of the at least one of the first insulating layer or the second insulating layer comprises at least one further/third fluid path for a heat exchange fluid (i.e. in the absence of the at least one further/third fluid path for a heat exchange fluid). Preferably the further means to control the temperature of the at least one fuel cell board comprises a second further insulating layer, wherein the second layer seals or caps the flow path of the further/fourth fluid path (acting as described for other embodiments herein). The first insulating layer of this further comprises further means to control the temperature of the at least one fuel cell board or adjacent fuel cell boards may be thicker than the second further insulating layer, or the second further insulating layer may be thinner than the first insulating layer of this further comprises further means to control the temperature of the at least one fuel cell board or adjacent fuel cell boards. This further means to control the temperature of the at least one fuel cell board or adjacent fuel cell boards may have multiple fluid paths for heat exchange fluid, of different sizes, shapes and/or dimensions, different fluid types, or fluids at different flow rates or different fluid temperatures. Fluids could be at different temperatures or different flow rates in different plates, or at different temperatures or at different flow rates in different flow paths within the same plate. This can address varying coolant need throughout a fuel cell. Preferably, where multiple further means to control the temperature of the at least one fuel cell board or adjacent fuel cell boards are present in a single fuel cell stack, each further means to control the temperature of the at least one fuel cell board or adjacent fuel cell boards may have different fluid paths, different sized, shaped or dimensioned fluid paths or be designed to carry different fluids, or different temperature fluids, or fluids with different flow rates. This can address varying coolant need throughout a fuel cell. The further/fourth fluid path can be routed or depth routed into the insulating layer of this plate.

Fuel cell stacks with these additional heat exchange layers are advantageous because they do not need to be open to input of coolant air, as described in prior art systems, and they are completely sealed to the atmosphere. Although the integration of heat exchange fluid paths in the first or second insulating layers, as described herein, is more space-efficient, utilising these additional heat exchange layers can increase power density when compared to prior art stacks due to the lack of non-functional spacer elements and the ability to supply reactant gases at a higher pressure thus increasing power density and reactant distribution on the electrodes.

Preferably, the face or surface of the first insulating layer adjacent to the cathodes in the fuel cell board is the face or surface which comprises the at least one first fluid flow path or channel, so that oxidant fluid can flow to or diffuse to the one or more of the cathodes of the MEA (all of the cathodes). This may be through a gas diffusion layer.

Preferably, the face or surface of the second insulating layer adjacent to the anodes in the fuel cell board is the face or surface which comprises the at least one second fluid flow path or channel, so that reductant fluid can flow to or diffuse to the one or more of the anodes of the MEA (all of the anodes). This may be through a gas diffusion layer.

Preferably, the Membrane Electrode Assembly (MEA) further comprises at least one gas diffusion layer. The one or more gas diffusion layer(s) may be between the at least one cathode or all of the cathodes and the first insulating layer and at least one or all of the first fluid path(s). The one or more gas diffusion layer(s) may be between the at least one anode or all of the anodes and the second insulating layer and at least one or all of the second fluid path(s). The MEA may comprise multiple gas diffusion layers as described herein.

Preferably, one or more of the layers described herein are laminated together. Preferably, one or more of the layers described herein can be mechanically pressed or compressed together, when in a fuel cell stack. This lamination or compression may be achieved or aided by chemical bonding by heating layers of prepeg between the insulating layers under pressure and an increased temperature, or with use of a sealant, as described herein.

Use of an epoxy resin prepreg also maintains compression of the gas diffusion layer of the MEAs, a critical component in maintaining fuel cell performance as it provides a sufficiently low resistance electrical path without compromising distribution of reactant fluids.

Preferably, the oxidant fluid, the reductant fluid and/or the one or more heat exchange fluids enter and leave the relevant fluid paths described herein via inlets and outlets. These inlets and outlets may connect the fluid paths to manifolds which supply the relevant fluids to the fluid paths. These manifolds are those described herein, but may be apertures in the insulating layers.

Preferably, each fuel cell board described in any aspect of the invention described herein is connected to an electronic circuit to produce an electrical output, and wherein the connection between each fuel cell board and the electronic circuit is individually switchable. Preferably, the connection between each fuel cell board in the fuel cell and an output line can be controlled by a switch mechanism such as a field-effect transistor (FET) switch, providing power handling and control directly at the cell. Each of these switches can be controlled by individual control lines. This can be by providing a switch on each fuel cell board.

Preferably, the oxidant fluid described in any aspect of the invention described herein is air and/or the reductant fluid is hydrogen gas.

Preferably, each fuel cell board may have a power rating of at least 10 W. Preferably, each fuel cell board may have a power rating of up to 1000 W. Preferably, each fuel cell board may have a power rating of 10 W to 1000 W. Preferably, a fuel cell comprising multiple fuel cell boards may have a power rating of at least 10 kW. Preferably, a fuel cell comprising multiple fuel cell boards may have a power rating of up to 1000 kW. Preferably, each fuel cell a fuel cell comprising multiple fuel cell boards may have a power rating of 10 kW to 1000 kW.

Preferably, the at least one fuel cell board may comprise at least one electrical connector configured to connect the at least one anode to the at least one cathode through the at least one ion permeable membrane. Connecting the anode to the cathode with the electrical connector through the ion permeable membrane allows an electrical current to flow in a direction along the plane of the membrane. Preferably, at least one through-membrane electrical connector may connect the electrodes across the membrane in a region where an anode and a cathode at least partially overlap, and the at least one through-membrane electrical connector may for example be produced by a homogeneous chemical deposition process.

An aspect of the present invention is a component for an electrochemical device. The component may comprise any of the features described herein related to the insulating layers for the fuel cell boards, they are interchangeable. It may comprise an insulating layer comprising at least one first fluid path on one face of the insulating layer and a second fluid path for a heat exchange fluid on the other or opposite face of the insulating layer. This may be termed a first insulating layer.

This may be a component for any type of electrochemical device where fluid flow control is important, and it would be advantageous to utilise heat exchange fluid flow in such a device. For example, this might be for a fuel cell as described herein. Or, this could be for an electrolyser or other such electrochemical device.

Preferably, the second fluid path is arranged on the opposite face of the insulating layer so there is no overlap in fluid path through the insulating layer of the at least one second path with the first fluid path. There is no overlap in the fluid paths so that the fluid paths never cross pathways. They may never cross pathways in that they never touch. Or they may never cross pathways through the body in the insulating layer such that each path never traverses the layer in the space (vertically) above the other flow path. The pathway of the at least one further/third fluid path does not cross the pathway of the other fluid path on the same insulating layer. The surface area of the face of the insulating layer covered by the at least one further/third fluid path is different to surface area of the face of the insulating layer covered by the other fluid path on the opposite face of the insulating layer (the first fluid path or the path of the second fluid path).

Preferably, the sum of the depth of the at least one first fluid path and the second fluid path may be equal to or greater than the thickness of the first insulating layer. This may be referred to as interdigitated channels. The channels run adjacent to each other, but never touch or cross paths. The thickness of the layer is the distance between the two faces of the layer which the at least two channels are found on. When there are multiple channels it may be the average of the depths of the fluid channels, not only one of.

Preferably, the insulating layer comprises a copper layer on the opposite side of the first insulating layer to the first fluid path. The insulating layer may also comprise a passivation layer on the copper layer. The second fluid path may be in the copper and/or in the passivation layer on the insulating layer. When found in the copper/passivation layer, this heat exchange fluid flow path may be open when viewed in isolation as a board.

Preferably, the component comprises a second insulating layer, wherein the insulating layer is located on or adjacent to the face of the first initial insulating layer which comprises the second fluid path so as to seal the second fluid path. The second insulating layer may thinner than the first insulating layer. This second insulating layer acts to “cap” or seal the flow paths which it is adjacent to. Here it could be adjacent to the at least one second fluid path and would act to seal this channel. Preferably, the second fluid path is in the second insulating layer, not the first insulating layer. Preferably, the second fluid path depth is equal to or greater than the thickness of the second insulating layer. Preferably, the second insulating layer is laminated to the fuel cell board. The one of more fluid paths sealed by this further/third insulating layer will be sealed so that any fluid flowing through these paths will only flow along/through the paths, along the intended path, and nowhere else.

Preferably, the depth of the first fluid path is equal to or greater than the thickness of the insulating layer and the second insulating layer seals one side of the first fluid path. Preferably, the second insulating layer may also comprise a passivation layer on the copper layer. The second fluid path is in the copper and/or in the passivating layer on the second insulating layer, and is not in or part of the first insulating layer/insulating core.

Preferably, the one or more insulating layers can comprise PCB layers, as described in the first aspect described above.

Preferably, one or more of the fluid flow paths is formed within or on an insulating layer such that the fluid flow path is routed or grooved within or through part of the body of one or more faces of the layer. In other words, the fluid flow path is formed without the routing or groove extending all the way through the layer. As can be seen throughout the figures herein, a fluid flow path or a route, provides a flow path for fluid within a single layer, as opposed to requiring one layer to provide a flow path, and another layer to provide a sealing face sealing the fluid path, as may be required in arrangements of the art. Depth routing to a depth is as described for the first embodiment of the invention.

Preferably, one or more of the flow paths described herein is routed through the whole body of the layer.

Preferably, the layers are laminated together. Preferably, the layers are mechanically pressed or compressed together.

Preferably, at least one of the first fluid path or the second fluid path or the third/further fluid path is substantially linear. Preferably, at least one of the first fluid path or the second fluid path is serpentine. Preferably, the fuel cell board comprises multiple first fluid paths and/or multiple second fluid paths. Preferably, the fuel cell board comprising at least one of the following: multiple first fluid paths which are substantially linear and substantially parallel with each other and/or multiple second fluid paths which are substantially linear and substantially parallel with each other. Preferably, the at least one second fluid path has a different flow path to the at least one first fluid path or. One of the paths may be substantially linear and the other serpentine. Preferably there are more of one of the multiple first fluid paths and/or multiple second fluid paths than the other fluid path, for example there may be more second fluid paths than the first fluid paths.

Preferably, the fluid paths are routed into the insulating layers. The fluid paths may be routed into the insulating layers prior to any copper plating of at least part of one or more of the insulating layers.

Preferably, the heat exchange fluid has a composition as described for the first aspect.

An aspect of the present invention provides the use of any fuel cell described herein.

An aspect of the present invention provides a method of using any fuel cell, or fuel cell component, or component for an electrochemical device as described herein.

As aspect of the present invention provides a method of thermally managing a fuel cell. The method comprises using a component or fuel cell board as described herein, which has a heat exchange fluid present as described herein, to manage the thermal properties of a fuel cell, or to transfer heat around a fuel cell.

### BRIEF DESCRIPTION OF THE DRAWINGS

Embodiments of the present disclosure will now be described with reference to the accompanying drawings, in which:

FIG. 1 shows a schematic side view of a stacked fuel cell of the prior art;

FIG. 2 shows a cross-section of a fuel cell of the prior art comprising a stack of fuel cell boards;

FIG. 3a shows an expanded embodiment of a fuel cell board of the present invention, FIG. 3b shows an alternative view of the same expanded embodiment of a fuel cell board of the present invention;

FIG. 4a shows an expanded embodiment of a fuel cell board of the present invention, FIG. 4b shows an alternative view of the same expanded embodiment of a fuel cell board of the present invention;

FIG. 5a shows one side of a cathode plate, FIG. 5b shows the other side of the same cathode plate;

FIG. 6a shows one side of an anode plate, FIG. 6b shows the other side of the same anode plate;

FIG. 7 shows a cap layer;

FIG. 8 shows an MEA layer;

FIGS. 9a, 9b, 9c, 9d, 10, 11, 12, 13, 14a, 14b, 15, 16, 17 and 18 show schematic representations of how fluid paths or fluid channels may be in the layers/plates described herein

FIG. 19a one side of a heat exchange plate, FIG. 19b shows one of the two layers which make up this heat exchange plate, FIG. 19c shows a side profile of the heat exchange plate;

FIG. 20 shows a schematic of a fuel cell stack of an embodiment;

FIG. 21 shows a simplified schematic of the fuel cell board layers of an embodiment; and

FIG. 22 shows a fuel cell of an embodiment.

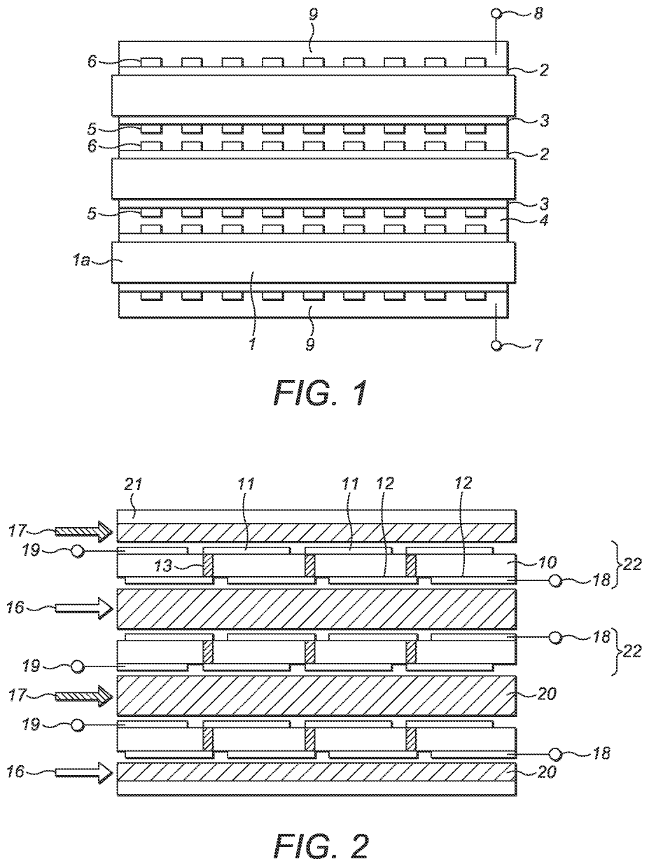

### DETAIL DESCRIPTION

Embodiments will now be described in detail with reference to the accompanying drawings. The same reference signs indicate the same or similar features in different figures and embodiment of the invention, although this is only for reference and is not limiting on the invention. In the following detailed description numerous specific details are set forth by way of examples, in order to provide a thorough understanding of the relevant teachings. However, it will be apparent to one of ordinary skill in the art that the present teachings may be practiced without these specific details.

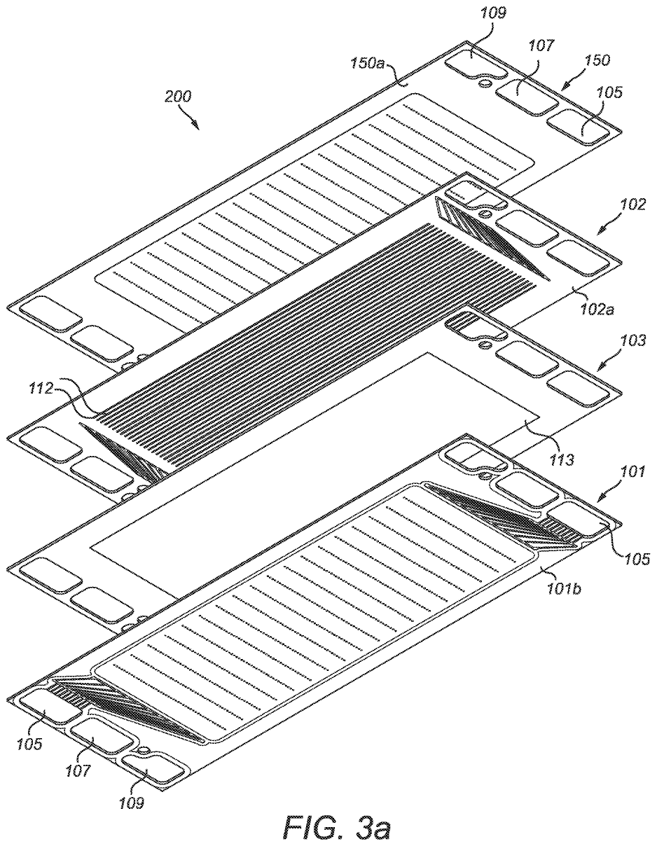

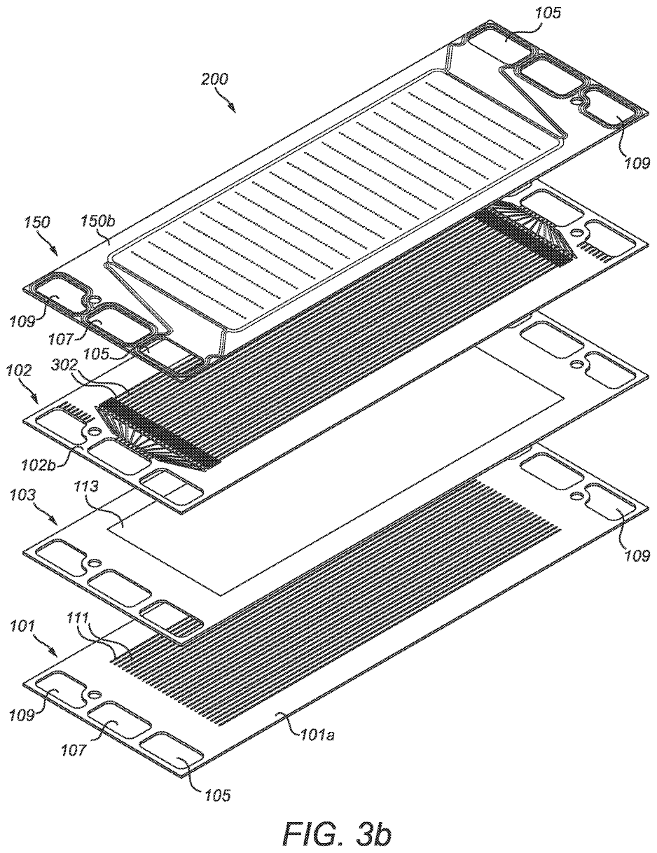

FIG. 3a is a schematic diagram of one view of an expanded fuel cell board 200 of an embodiment. Fuel cell board 200 is shown expanded for the purposes of this figure, to show the membrane electrode assembly (MEA) layer 103 comprising MEA 113 separated from cathode plate 101, anode plate 102 and cap layer 150. The cathode plate may be the first insulating layer as described herein. The anode plate may be the second insulating layer as described herein.

One single MEA 113 is present here, as described in more detail herein. This MEA 113 comprises an ion permeable membrane, an anode/anode layer and a cathode/cathode layer. The cathode layer is the side of the MEA layer 103 so that it is adjacent cathode plate 101 and the anode layer is the side of the MEA layer 103 so that it is adjacent anode plate 102. Here there is just a single cathode and a single anode either side of an ion permeable membrane. In this embodiment the MEA 113 is laminated between the cathode plate 101 and anode plate 102, but are shown separated/expanded in this figure just to show their presence. The lamination process is described later. The MEA layer 103 comprises a sealing/lamination material such as prepreg, visible in MEA layer 103 as the non-MEA 113 area. 113 shows the MEA which can include a gas diffusion layer. The ion permeable membrane extends beyond this area for a small distance (around 0.2 mm all the way to the edge of the module), to form a seal with the prepreg. The ion permeable membrane is sandwiched between prepreg in this area.

This shows one embodiment of an MEA suitable for use for the embodiments described here. Other MEA designs, shapes, orientations would be known to a person of skill in the art and understood to be suitable with the present embodiments.

Cathode plate 101 and anode plate 102 here are partially copper plated printed circuit boards (PCBs), but in embodiments herein could be layers of any insulating material as described herein. In a fuel cell board 200 the cathode plate 101 and anode plate 102 are laminated together with the MEA 113, the MEA between the cathode plate 101 and anode plate 102, with cap layer 150 to form a fuel cell board 200. In FIG. 3a inner face 102a of anode plate 102 is visible. The inner faces of both cathode plate 101 and anode plate 102 (101a and 102a respectively) are plated with copper and routed with flow field 111, 112 designs, with a passivation ink screen printed over the flow field 111, 112 surfaces (on the inner faces 101a, 102a of both plates 101, 102) to prevent degradation. Flow fields 112 are visible on the inner face 102a and the anode plate in FIG. 3a (flow fields 111 are visible on the inner face 101a of the cathode plate 101 in FIG. 3b, not visible in FIG. 3a). Two flow field paths 112 of the multiple parallel flow paths visible are labelled in FIG. 3a. Multiple single flow fields 111, 112 make up the ‘flow field’ for each plate, and flow field(s) may be referred to in the singular or as a plurality throughout. Flow fields 111, 112 are shown as parallel flow paths going across each layer from one side of the layers to the other side of the plates 101, 102. The flow fields 111 on the cathode plate 101 may be the first fluid paths as described herein and the flow fields 112 on the anode plate 102 may be the second fluid paths as described herein.

FIG. 3a shows capping layer 150. Inner face 150a of capping layer 150 is shown, which when laminated with the other layers shown will be adjacent to face 102b of anode board 102. Capping layer 150 has cathode manifold 105, heat exchange fluid manifold 107 and anode manifold 109 labelled. Capping layer 150 has multiple 18 rows of plated through holes also visible (not labelled). Capping layer 150 may be the third/further insulating layer as described herein.

In the specific embodiment displayed in FIGS. 3a and 3b, but also generally in all embodiments, flow fields are routed into the PCB to provide a path for the reactants (for example air, hydrogen) to be supplied to the cathodes and anodes. Oxidant fluids flow only to all of or one or more of the cathodes and reductant fluids flow only to all of or one or more of the anodes of each fuel cell board. Reference herein to ‘oxidant fluids’ refers to fluids that will react at the cathode, oxidants, for example air or oxygen. Reference ‘reductant fluids’ refers to fluids that will react at the anode, reductants, for example hydrogen. The MEA 113 is located between the anode plate (first insulating layer) 102 and the cathode plate (second insulating layer) 101 so that the at least one first fluid path 111 of the cathode plate 101 is arranged such that an oxidant fluid can flow to all of cathodes of the MEA 113 and the anode plate 102 is arranged so that the at least one second fluid path 112 is arranged such that a reductant can fluid flow to the all of the anodes of the MEA 113.

‘Fluid path’, ‘fluid channel’, ‘flow path’, ‘fluid flow path’ ‘fluidic path’, ‘flow field’ and ‘channel’ may all be used interchangeably herein and may be substituted for one another herein. They all refer to means by which fluids can flow or travel along, down or through. Fluids may be substantially directed, either with or without assistance, along fluid flow paths, channels or the like.

The flow paths are channels routed into the PCBs. In this embodiment the fluid paths are shown not to be routed through the whole body or volume of the board, although in other embodiments they may be through the whole of the layer. Here there may be a routing or drilling through the board at the inlet or outlet end to allow flow. The present arrangement allows effective separation of the reactants for the anodes and the cathodes. When the boards are laminated or mechanically compressed together, the flow fields are located over the relevant part of the MEA 113 (the anode flow field over the anodes, the cathode flow fields over the cathodes), so as to supply the relevant reactant directly to the anodes and the cathodes. The pressure of the reactant fluids supplied ensures a reaction at the anodes and the cathodes. Reactants will enter one side or corner of the plate and leave via the opposing or opposite side or corner of the plate. Face 101b of cathode plate 101 shows flow fields passing through the body of the board to cathode manifold 105. Flow fields 111 are connected to these paths and are visible on the other (not shown) face (101a) of cathode plate 101 This face 101b of cathode plate 101 also has 18 rows of plated through holes also visible (not labelled).

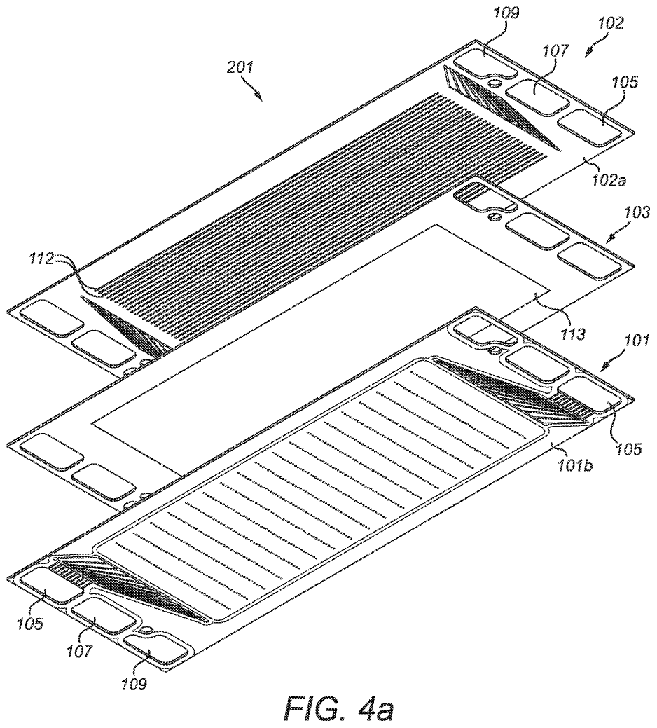

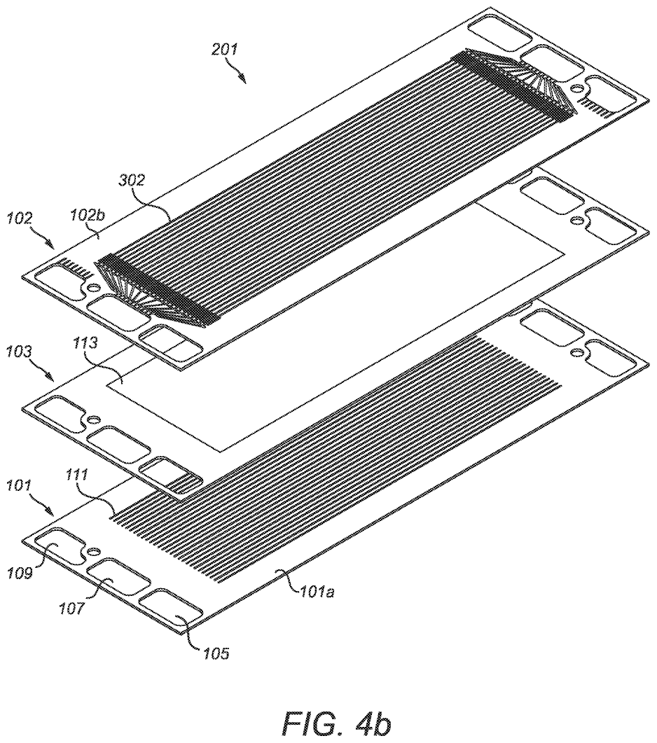

Various channels/fluids paths/flow field patterns and entry and exit points on a plate to the plate will be known to those of skill in the art. For example, flow paths can be serpentine, circular or linear substantially straight across a plate (such as the channels shown to be parallel with each other in FIGS. 3 and 4 and later embodiments). Flow fields can enter and leave by the same edge of a plate or opposing sides or corners of the plates. It is advantageous to have flow of reactants enter and leave opposite sides of the plate so that the reactant manifolds can easily be separated on opposing sides of a fuel cell. Channels may be different on different faces of plates, for example one face of a plate may have one or more serpentine flow path and one face may have parallel flow paths.

The outer faces 101b, 102b of plates 101, 102 are also copper plated in part and are routed with the desired copper design.

Cathode manifold 105 supplies compressed reactant fluid, and it is via cathode manifold 105 reactant air leaves cathode plate 101 and the fuel cell board 200 as a whole. This may be air which comes from the atmosphere i.e. outside of the fuel cell, but it enters the fuel cell system via an air compressor (as opposed to a fan as may occur in later embodiments). This enables higher pressures of air to be achieved, although there is an increased parasitic energy cost to operate such a compressor over a fan.

Heat exchange fluid manifold 107 and anode manifold 109 are also visible in FIG. 3a, and may be drilled or routed into the plates after lamination, or possibly before lamination or compression. The manifold holes are visible in all layers of the fuel cell stacks and individual layers throughout, but not all holes are labelled in every figure. Equivalent holes line up with equivalent holes when plates are stacked. Generally, for all embodiments herein, manifolds of any appropriate size, dimension and shape supply and collect the reactants and heat exchange fluids, or any other relevant substances, into and out of the inlets and outlets of fuel cell boards. Vertical channels up and down fuel cell stacks are connected to manifolds along the two opposed edges of the stack, which supply and collect the reactants, heat exchange fluids (e.g. coolants) etc. to and from boards. These may be drilled or routed into the individual boards before or after lamination to other boards.

The plates may also have holes drilled or routed for bolting holes, and/or alignment pins can be inserted into these.

FIG. 3b is a schematic diagram of an opposing view to FIG. 3a of the same expanded fuel cell board 200. Fuel cell board 200 is shown expanded for the purposes of this figure, to show membrane electrode assemblies (MEAs) 113 separated from cathode plate 101, anode plate 102 and cap layer 150.

Only inner face 101a of cathode plate 101 and outer face 102b of anode plate 102 are visible in FIG. 3b. The cathode flow fields 111 are visible on the inner face 101a of cathode plate 101 (two flow fields 111 are labelled in FIG. 3b but multiple flow field paths 111 are visible). A passivation ink is also screen printed over this flow field surface. In FIG. 3b the flow fields 112 for the anode plate 102 are not visible, it is on the not visible inner face 102a of the cathode plate 102.

Anode manifold 105, heat exchange fluid manifold 107 and cathode manifold 105 are also visible in FIG. 3b.

Heat exchange fluid paths 302 can be seen in FIG. 3b (not visible in FIG. 3a), on face 102b of anode plate 102. Two paths 302 of the multiple shown are labelled. These connect to heat exchange fluid manifold 107. These supply a heat exchange fluid to the flow paths on side 102b of anode plate 102. Here cap layer 150 is also visible, but face 150b is visible from this angle. Heat exchange fluid paths 302 may be the third/further fluid paths for a heat exchange fluid as described herein.

Cap layer 150 here, and as described herein, acts to “cap” or seal the flow paths which it is adjacent to. Here, it is shown adjacent to the flow paths 302 on anode plate 102. When the layers in FIGS. 3a and 3b are laminated or compressed together cap layer 150 will seal flow paths 302 on anode plate 102, so the heat exchange fluid flowing through these paths will only flow along/through the paths, along the intended path, and nowhere else. Cap layer 150 is relatively featureless, just shown with rows of plated through holes to conduct current from the anode plate through the body of the insulating material from which cap layer 150 is made from. This layer is described as a third or fourth layer throughout, to the first and second layers which are the cathode and anode plates.

If the heat exchange fluid paths were found on a cathode plate, the cap layer could be located adjacent the plate face with the heat exchange paths (for example here cathode plate face 101b could have the heat exchange fluid paths 302 and cap layer 150 could be adjacent the cathode plate 101, the other side of the fuel cell board 200 shown).

FIG. 4a is a schematic diagram of one view of an expanded fuel cell board 201 of an embodiment. Fuel cell board 201 is shown expanded for the purposes of this figure, to show the membrane electrode assembly (MEA) layer 103 comprising MEA 113 separated from cathode plate 101 and anode plate 102. Here, compared to fuel cell board 200, there is no cap layer present. All other features are the same and labelled accordingly.

Here, if there were multiple fuel cell boards 102 in a fuel cell stack, stacked so anodes of the MEA faced cathodes of the MEA of the adjacent fuel cell board, then exposed heat exchange fluid paths 302 on face 102b of anode plate 102 would be adjacent face 101b of adjacent cathode plate 101. When laminated or compressed together face 101b of adjacent cathode plate 101 would act to cap or seal the channels 302 so that fluid could flow down the channels, but not out in an intended direction. A cap layer 150 is not necessary in this design.

FIG. 4b is a schematic diagram of an opposing view to FIG. 4a of the same expanded fuel cell board 201. Fuel cell board 201 is also shown expanded for the purposes of this figure, to show membrane electrode assemblies (MEAs) 113 separated from cathode plate 101 and anode plate 102. Here, compared to fuel cell board 200, there is no cap layer present. Here heat exchange fluid paths 302 are visible on face 102b of anode plate 102.

As with the embodiment shown in FIGS. 3a and 3b, heat exchange fluid paths 302 could be located on face 101b of cathode plate 101.

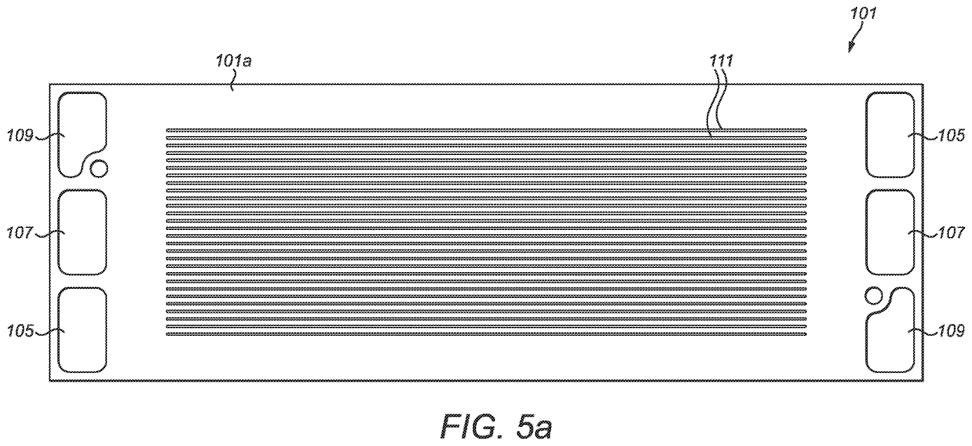

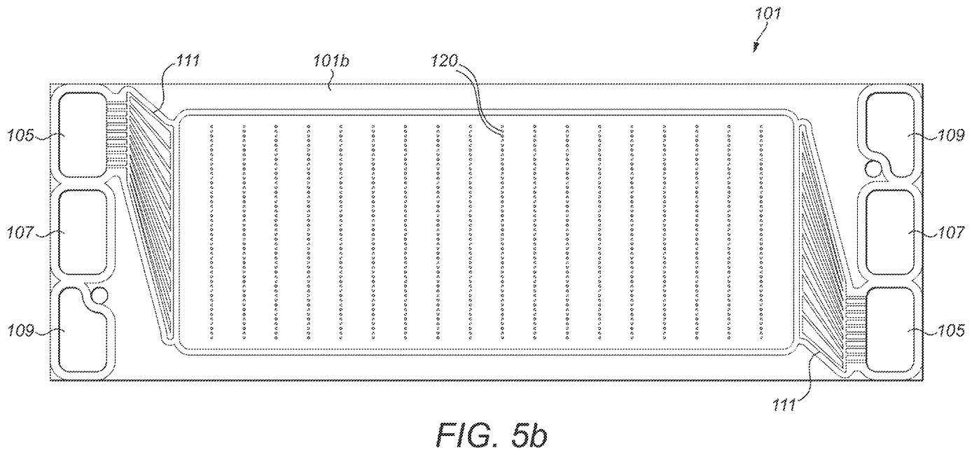

FIG. 5a shows the inner face 101a of the cathode plate 101 of an embodiment. Parallel flow fields 111 are clearly visible, two of the multiple flow fields 111 are labelled, and the flow fields 111 are routed into the inner face 101a of the cathode PCB plate 101. Cathode manifold 105, heat exchange fluid manifold 107 and anode manifold 109 are all visible. Flow fields 111 pass through the body of the board to cathode manifold 109 on the other side of the plate, as visible in FIG. 5b.

FIG. 5b shows the outer face 101b of the cathode plate 101 of an embodiment. Cathode manifold 105, coolant manifold 107, anode manifold 109 and plated through holes 120 are all shown. Here the flow fields 111 connect to cathode manifold 105.

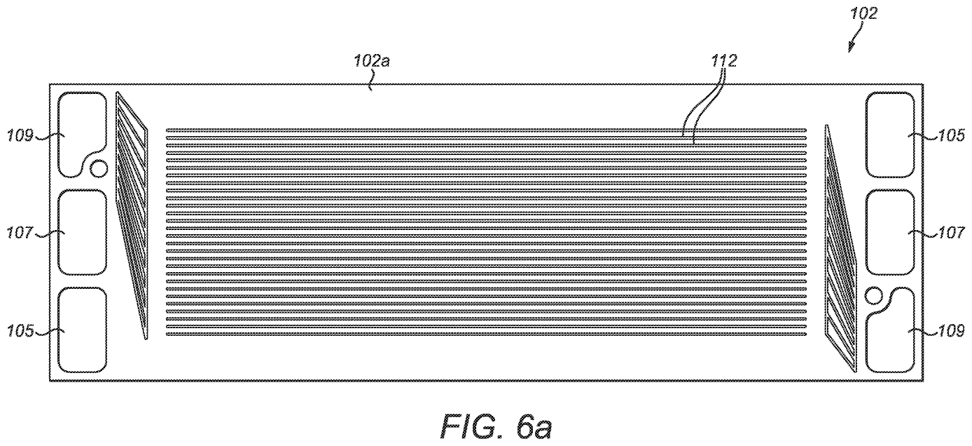

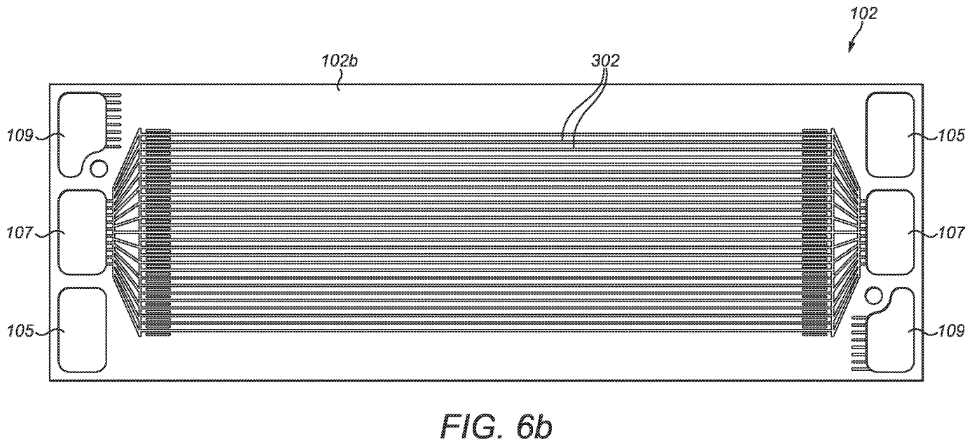

FIG. 6a shows the inner face 102a of the anode plate 102 of an embodiment. Parallel flow fields 112 are clearly visible, two of the 28 flow fields 112 are labelled, routed into the inner face 102a of the anode PCB plate 102. Cathode manifold 105, coolant manifold 107 and anode manifold 109 are all shown. Reactant hydrogen is supplied and leaves through anode manifold 109 into/out of to the anode flow fields 112.

FIG. 6b shows the outer face 102b of the anode plate 102 of an embodiment. Cathode manifold 105, heat exchange fluid manifold 107 and anode manifold 109 are also labelled. Here, heat exchange fluid paths 302 can be seen on face 102b of anode plate 102. Two paths 302 of the multiple shown are labelled. These connect to heat exchange fluid manifold 107. These supply a heat exchange fluid to the flow paths on side 102b of anode plate 102.

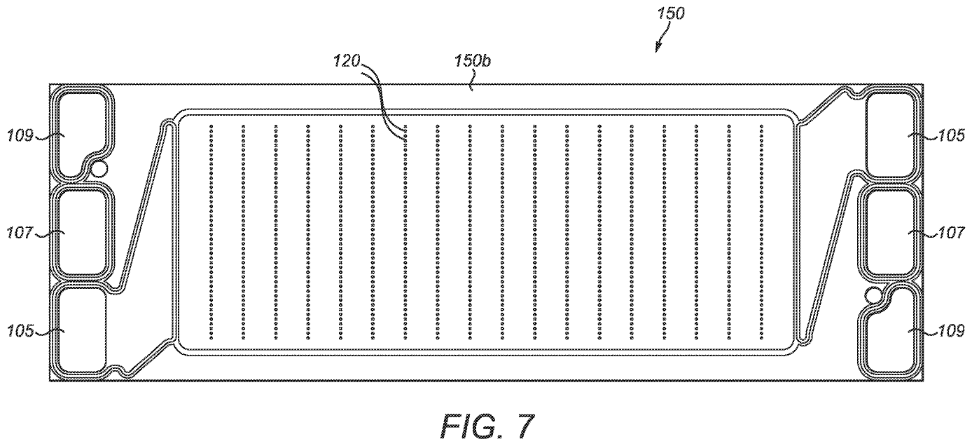

FIG. 7 shows a cap layer 150 or what may be called a “further layer” or third/fourth layer herein. Shown with rows of plated through holes 120 (two labelled) to conduct current through the body of the insulating material from which cap layer 150 is made from. Cathode manifold 105, heat exchange fluid manifold 107 and anode manifold 109 are also labelled.

FIG. 8 shows MEA layer 103 of an embodiment. This is separated from cathode plate 101, anode plate 102 and the possible cap layer 150. One single MEA 113 is present here, a rectangular shape. This MEA 113 comprises an ion permeable membrane, an anode/anode layer and a cathode/cathode layer. Such MEA layers may have multiple membranes, anodes or cathodes, in various arrangements as described herein.

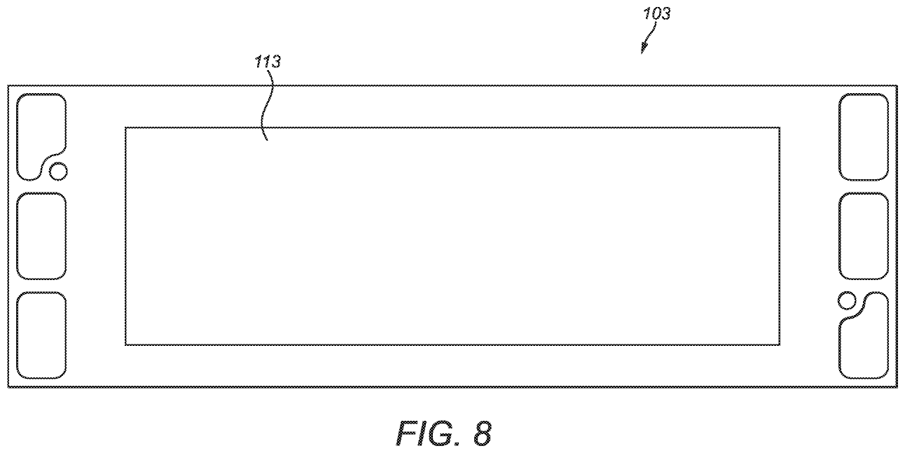

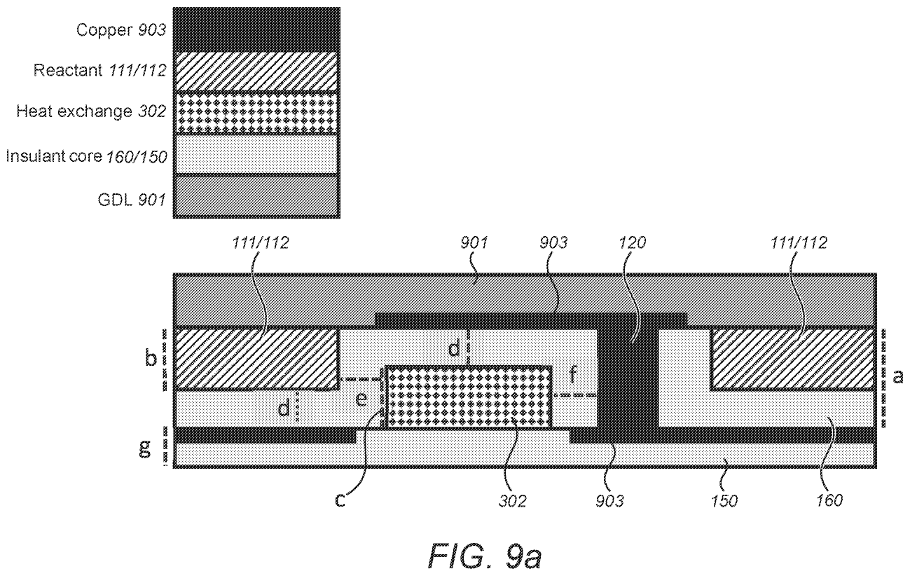

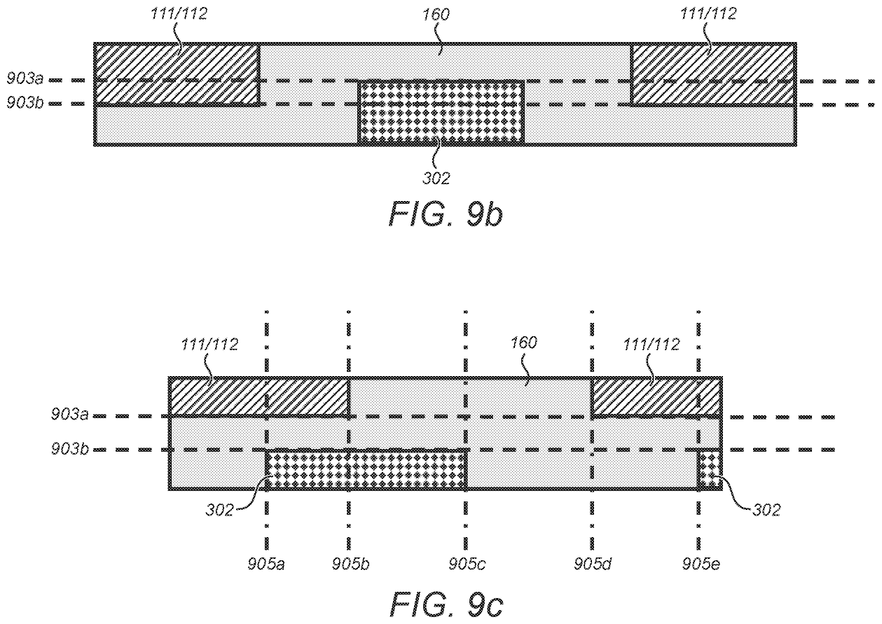

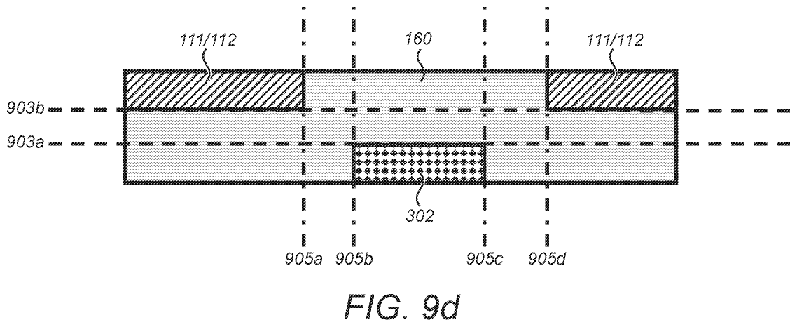

FIG. 9a shows a schematic representation of how fluid paths or fluid channels may be in the layers/plates described herein. Here an insulating core layer 160 is shown, which is equivalent to an ‘insulating layer’ as described herein. This is a core of insulating material and may have conductive material plating/passivation layers on, which may also be considered part of the insulating layer. The insulating core 160 shown here could be cathode plate 101 or anode plate 102 as described above. Here copper plating 903 can be seen across at least part of both faces of the insulating core 160. This copper plating 903 run downs plated through hole 120, which goes through the whole body of the insulating core 160 and electrically connects the two layers of copper 903.

FIG. 9a shows heat exchange fluid path 302 in the layer of the insulating material 101, 102, along with reactant fluid paths 111, 112 also in the body of the layer of insulating material. Reactant fluid paths 111, 112 may carry oxidant or reductant fluids to the cathodes or the anodes as described herein. Here they are shown adjacent to a GDL layer 901, which will allow the fluids to diffuse to the cathodes or anodes of an MEA. The GDL is an optional feature of all embodiments described herein and is located between the flow field and the anodes/cathodes of the MEAs. Here, this is just a cross section of a representative insulating layer where the edges of channels are cut off. The plate and all plates shown in FIGS. 9a to 13 and other such figures are just a cross section of a plate which may have multiple or each channel shown across the plate.

Here just one heat exchange fluid path 302 and two reactant fluid paths 111, 112 are shown, but in embodiments herein multiple of each could be present in each insulating board described herein. Or just one of each may be present. These flow paths may have varying designs i.e. patterns, fields, geometries or arrangements as described herein.

FIG. 9a shows that heat exchange fluid paths 302 can be integrated in the same insulating core 160 as the fluid paths (channels) 111, 112 to supply fluids to the MEA. Here, the heat exchange fluid path 302 is on the opposite face of the insulating layer to the two reactant fluid paths 111, 112.

FIG. 9a shows that heat exchange fluid path 302 can also be interdigitated with the reactant fluid paths 111, 112. Here, the heat exchange fluid path 302 has no overlap in the path of or the body of the heat exchange fluid path 302 through the insulating core 160 of the heat exchange fluid path 302 with the path of the reactant fluid paths 111, 112. That is there is no overlap in that the fluid paths never cross paths or touch. In addition or alternatively, they do not cross or overlap in pathways through the body of the insulating layer such that each path never traverses the insulating core 160 in the space (vertically) above the other flow path. The surface area of the face of the insulating layer 101/102 covered by the heat exchange fluid path 302 is different to surface area of the face of the insulating core 160 covered by the reactant fluid paths 111, 112.

The interdigitation of flow paths can also be defined in terms of axes. FIG. 9b shows a simplified version of FIG. 9a, with two labelled ‘y’ axes added-axis 903a and axis 903b. Axes 903a and 903b are parallel to the top and bottom faces/surfaces of the insulating core 160. Axis 903a is defined as parallel to the top of flow path 302. Axis 903b is defined as parallel to the bottom of flow paths 111/112. In order to be considered interdigitated, at least part of flow paths 302 must cross or overlap with axis 903b and/or or at least part of flow paths 111/112 must cross or overlap with axis 903a. Here, there is such an overlap, as these are considered interdigitated.

In embodiments herein, fluid flow paths may cross with or overlap an axis defined by the top or bottom of another flow path on/in the same insulating board which is on the opposite face of the same insulating board, wherein these axes are parallel to the two surfaces of the insulating board in which these two or more flow paths are found. These flow paths would be considered integrated on the same board, and also interdigitated with each other.

In embodiments herein, fluid flow paths may not cross with or overlap an axis (or one or more axes) defined by the top or bottom of another flow path on/in the same insulating board which is on the opposite face of the same insulating board, wherein this axis is parallel to the two surfaces of the insulating board in which these two or more flow paths are found. These flow paths would be considered integrated on/in the same board, but not interdigitated with each other.

An alternative embodiment is shown in FIG. 9c. Here the flow paths are shown to be integrated on the same insulating layer, but not interdigitated. The flow paths can also be defined in terms of axes. FIG. 9c has two labelled ‘y’ axes added-axis 903a and axis 903b. Axes 903a and 903b are parallel to the top and bottom faces/surfaces of the insulating core 160. Axis 903a is defined as parallel to the top of flow path 302. Axis 903b is defined as parallel to the bottom of flow paths 111/112. Here, there is no overlap in flow path or crossing of the flow path of any flow path with the axis defined by the top or bottom of the flow path found on the opposing face of the insulating core 160. These flow paths are not considered interdigitated because of this lack of overlap or crossing. These flow paths are considered integrated on the same plate.

In FIG. 9c there is an overlap in the fluid path through the body of the insulating layer of flow path 302 with flow paths 111/112 on the opposite face/surface of the insulating layer. This can also be defined by axes. Vertical ‘x’ axes 905a, 905b, 905c, 905d, 905e are defined by the edges of the flow paths, but could also be defined by any point of these flow paths. Here, there is a cross with or an overlap in the fluid flow paths with some or all of the axes defined by vertical the edge of or a point within a flow path on the opposite face/surface of the insulating layer. These axes (905a, 905b, 905c, 905d, 905e) are orthogonal to the axes (903a and 903b) defined by the top and bottom of the flow paths and the two surfaces of the insulating layers which the flow paths are found.

This contrasts to FIG. 9d, where similar vertical ‘x’ axes 905a, 905b, 905c, 905d, 905e are defined by the edges of the flow paths are also defined. However, here there is no cross with or an overlap in the fluid flow paths with some or all of the axes defined by vertical the edge of or a point within a flow path on the opposite face/surface of the insulating layer.

In the arrangements shown in FIG. 9a and FIG. 9b there is also no such cross with or overlap in the fluid flow paths with some or all of the axes defined by vertical the edge of or a point within a flow path on the opposite face/surface of the insulating layer. No point of flow path 302 or flow paths 111/112 crosses with an axis (any of 905a, 905b, 905c, 905d, 905e) defined by the vertical edge of or a point within a flow path on the opposite face/surface of the insulating layer.

In embodiments herein, fluid flow paths may not cross with or overlap an axis defined by a vertical edge of another flow path which is on/in the same insulating board but on the opposite face of the same insulating board, wherein these axes are orthogonal to an axis parallel to the two surfaces of the insulating board in which these two or more flow paths are found. These flow paths would be considered integrated on the same board, and may be interdigitated with each other. When interdigitated with each other, the fluid flow paths may cross with or overlap a second axis defined by the top or bottom of the another flow path on/in the same insulating board which is on the opposite face of the same insulating board, wherein this second axis is parallel to the two surfaces of the insulating board on/in which these two or more flow paths are found. These flow paths would be considered integrated on the same board, and also interdigitated with each other.

Interdigitated flow paths may also be described as sums of the depths of flow paths or the channels. In embodiments, the sum of the depth of the flow paths may be equal to or greater than the thickness of the insulating board. In FIGS. 9a and 9b the sum of the depth of flow paths 302 and 111/112 equal to or greater than the thickness of the insulating layer. The flow paths run adjacent to each other, but never touch or cross paths. This is preferably when the flow paths are on opposite faces of the same insulating layer. The thickness of the layer is the distance between the two faces of the layer which the at least two flow paths are found on. In FIGS. 9c and 9d the sum of the flow paths 111/112 and 302 would be less than the thickness of the board.

Interdigitated flow paths may also be described as relative heights or top/bottoms of each flow path. The bottom of or the depth of one flow path will be lower or less than the height or the top of the other path on the same insulating board. In FIGS. 9a and 9b the top of flow path 302 is higher than the bottoms of flow paths 111/112. In FIGS. 9c and 9d the height of the flow paths 111/112 higher than the height of flow path 302 or the height of flow path 302 is lower than the height of flow path 111/112.

Interdigitation of flow paths is possible with using insulating material layers such as PCB boards. It is not possible with metal fuel cell boards as described in the prior art, particularly metal fuel cell boards. Interdigitation results in a reduced thickness of fuel cell boards, with space saving, lighter fuel cell boards and increased power density in fuel cell stacks.

In some embodiments herein, all flow paths or channels in both faces of insulating layers will cross an axis directly through the exact middle of the insulating layer, which is parallel with bottom faces/surfaces of the insulating layer, and/or is defined as parallel to the top or bottom of each of all flow paths found on both faces/surfaces of the insulating layer.

FIG. 9a also has cap layer 150. This additional layer of insulating material or additional insulating layer seals or caps flow path 302.

Additional layers of insulating material or additional insulating layers may be added to seal or cap one or more of these channels, as described herein. This is adjacent the layer with the flow path for the heat exchange fluid. This acts to seal or cap this path, so that any fluid flowing through these paths will only flow along/through this path, along the intended path, and nowhere else. This layer is laminated to the insulating layer 101/102, or can be held in place by compression in a stack of such boards or components. Copper plating 903 can carry electrical current between these two layers of insulating material. Layer 150 is thinner than insulating layer 101/102. This layer may be referred to as the further (to the first and second insulating layers forming the cathode and anode plates), third or fourth insulating layer in embodiments here. These layers may comprise the thermal exchange fluid pathways, in the core of the layer or in the copper/ink layers present on or as part of these layers (negative space-type flow paths).

These capping or further insulating layers may be of varying thinness. Capping or further insulating layers as described herein may be rigid layers of insulating material, such as rigid PCBs, or may be thinner flexible layers of insulating material, such as flexible PCBs. These can be copper plated and have a passivation layer on, they would still be flexible.

FIG. 9a has various distances labelled. These just represent one exemplary embodiment of the invention, but demonstrate relative distances of the various parts of this embodiment. These exemplary dimensions can be found in Table 1:

TABLE 1

| Symbol in | | |
|---|---|---|
| FIG. 9a | Feature | Distance |
| a | Insulating core 160 thickness | 100 μm to 1300 μm |
| b | Reactant flow channel 111/112 depth | 50 μm to 1300 μm |
| c | Heat exchange fluid channel 302 depth | Can be same as the |
| | | reactant channel |
| d | Distance between bottom of Reactant | Min 50 μm |
| | flow channel 111/112 and edge of | |
| | insulating layer 101/102 | |
| e | Distance between edge of two of the | Min 50 μm |
| | fluid channels 302 and 111/112 | |
| f | Distance between edge of Heat | Min 100 μm |
| | exchange fluid channel 302 and | |
| | plated through hole 120 | |
| g | Capping layer thickness | 100 μm to 1300 μm |

Further, insulating layers may comprise at least a partial layer of or plating of conductive material, e.g. copper, as described herein. This may have a thickness of 15 μm to 120 μm.

Further, insulating layers may comprise at least a partial passivation layer, e.g. passivation ink, as described herein. This may have a thickness of 3 μm to 100 μm, preferably 15 μm to 90 μm. For example, for a passivation ink layer this may be 15 μm to 90 μm, for a ENIG layer this may be between 3 μm to 10 μm, preferably 3 μm to 6 μm.

Flow paths or channels may be found in just these conductive material and passivation layers. The negative space, which can be considered heat exchange channels, may have a depth of between 180 and 500 microns and a width greater than 100 microns, with the upper limit dependent on the geometry of the flow paths/channels chosen. These may be formed by etching a conductive material (e.g. copper) layer deposited on the insulating core, and then application of a passivation layer which will deposit on just the remaining conductive material (e.g. copper).

The fuel cell boards may be constructed in any suitable and desirable dimensions. In some embodiments, the thickness of the electrolyte membrane layer may be between 1-200 μm, and preferably between 5-100 μm. The electrode band may be up to 500 by 500 mm, preferably 300×100 mm, 300×200 mm or 300×300 mm. The electrode bands may be 1 mm-10 cm in width, preferably 2 mm-5 cm in width. If present, the gaps between the electrode bands may be between 0.1 mm-1.5 cm wide, preferably between 0.2 mm and 1 cm wide. The width of the through-membrane electrical connectors may be 1 μm-2 mm and preferably 10 μm-1 mm.

These parameters and distances may be applied to embodiments here. These embodiments and features may also apply to the component for an electrochemical device described herein.

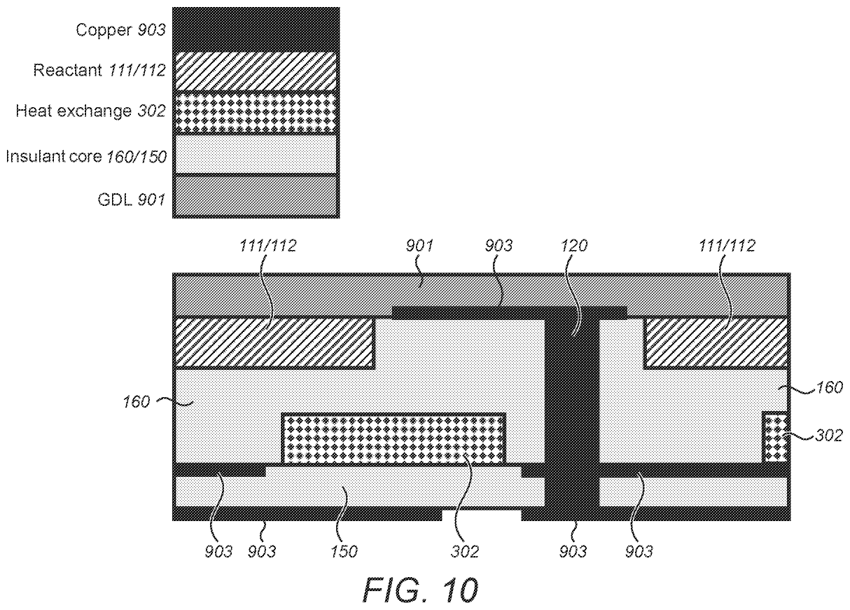

FIG. 10. shows a further embodiment. FIG. 10. Shows a schematic representation of how fluid paths or fluid channels may be in the layers/plates described herein. The insulating core 160 shown here could be within the cathode plate 101 or anode plate 102 as described above. Here copper plating 903 can be seen across at least part of both faces of the insulating core 160. This copper plating 903 run downs plated through hole 120, which goes through the whole body of the insulating core 160 and electrically connects the two layers of copper 903. Copper plated through hole 120 also goes through the whole body of capping layer 150 and to a further copper plating layer of capping layer 150.

In embodiments herein, the further insulating layer/the capping layer may comprise copper plating and/or means to conduct electrical current from one face of the capping layer to the other face, for example plated through holes.

FIG. 10. shows heat exchange fluid path 302 in the layer of the insulating material 101, 102, along with reactant fluid paths 111, 112. These act as described in FIG. 9a. Here two heat exchange fluid paths 302 and two reactant fluid paths 111, 112 are shown. Here, this is just a cross section of a representative insulating layer where the edges of channels are cut off.

FIG. 10 shows that the heat exchange fluid paths 302 can be integrated in the same insulating core 160 as the fluid paths (channels) 111, 112, and paths 302 are on the opposite face of the insulating layer to the two reactant fluid paths 111, 112. FIG. 10 shows paths that are not interdigitated. As described above in FIG. 9c (FIG. 10 has the same path arrangement as FIG. 9c), these paths are not interdigitated. Paths 302 have an overlap in the path of or their body through the insulating core 160 with the path of the reactant fluid paths 111, 112. Paths 302 cross or overlap in pathways through the body of the insulating layer such that each path traverses the insulating core 160 in the space (vertically) above the other flow path.

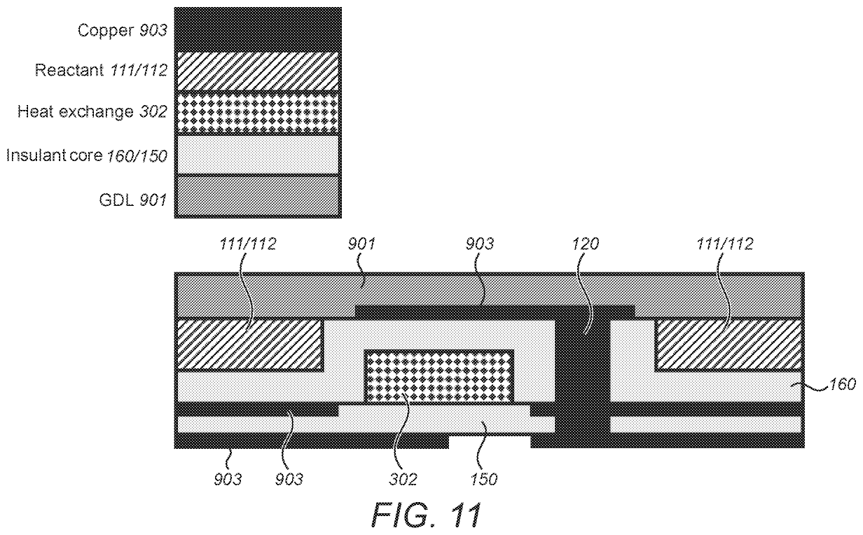

FIG. 11. shows a further embodiment. FIG. 11 shows a schematic representation of how fluid paths or fluid channels may be in the layers/plates described herein. FIG. 11 has the same path arrangement as FIG. 9a, but here the further components are shown as in FIG. 9a and others. Here copper plated through hole 120 also goes through the whole body of capping layer 150 and to a further copper plating as part of/on capping layer 150. Flow paths here are integrated and interdigitated.

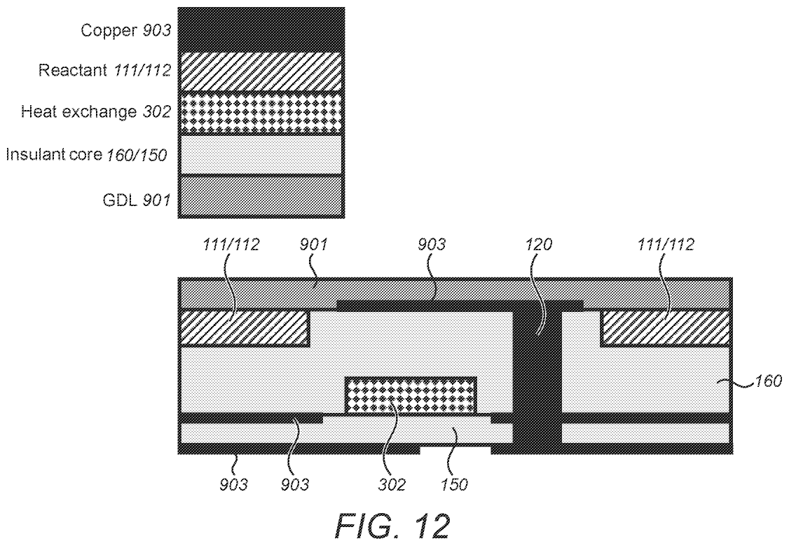

FIG. 12. shows a further embodiment. FIG. 12 shows a schematic representation of how fluid paths or fluid channels may be in the layers/plates described herein. FIG. 12 has the same path arrangement as FIG. 9d, but here the further components are shown as in FIG. 9a and others. Here copper plated through hole 120 goes through the whole body of capping layer 150 and to a further copper plating as part of/on capping layer 150. Flow paths here are integrated and interdigitated.

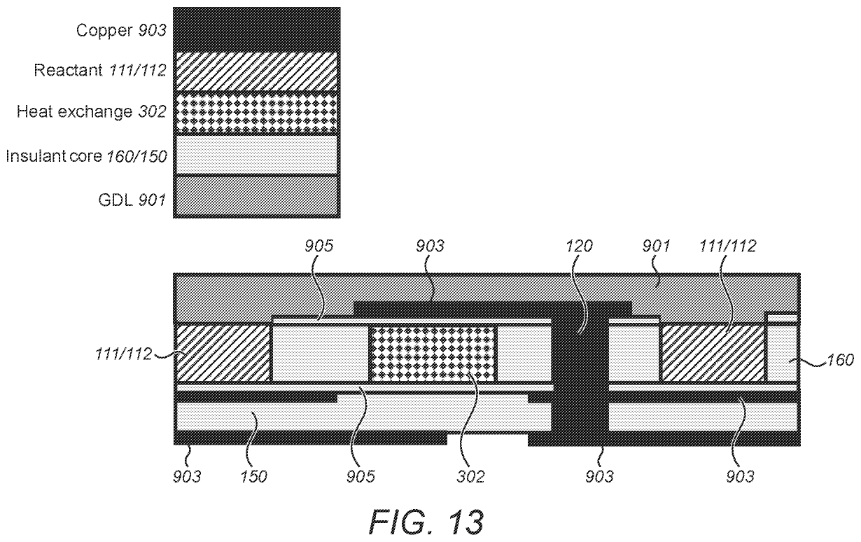

FIG. 13 shows a further embodiment. FIG. 13 shows a schematic representation of how fluid paths or fluid channels may be in the layers/plates described herein. Here, reactant flow paths 111,112 and coolant flow path 302 are shown through the whole body of the insulating core 160. Here the depth of each of or both of the reactant flow paths 111,112 and coolant flow path 302 are equal than the thickness of the insulating layer. This means that the fluid channel/flow path/channel is open to both faces or surfaces of the single insulating core 160 shown here. Additional layers of insulating material or additional insulating layers or additional capping layers 150 are present to seal or cap both sides of flow path 302. These may be individually added or a continuous layer added to cap or cover one or more of the flow paths. But no additional layers of insulating material or additional insulating layers are present to seal or cap at least one side of reactant flow paths 111,112, the sides adjacent the GDL 901, so that reactants can flow or diffuse to the anodes or cathodes. A capping layer of the correct design may be added, or a single capping layer may be added to/laminated with a layer of insulating material and drilled or routed to expose the relevant fluid paths (or both a capping layer and a layer of insulating material may be drilled or routed together to create a fluid path and exposure through the capping layer to said fluid path). The side of reactant flow paths 111,112 not adjacent to the GDL 901 are capped with additional insulating material, here cap layer 150.

This embodiment may be advantageous over other described embodiments because having the reactant supply channels and the heat exchange fluid channels in the same plane allows for the insulating layer to be thinner than before. This can reduce weight, manufacturing costs and reduce stack size, increasing power density.

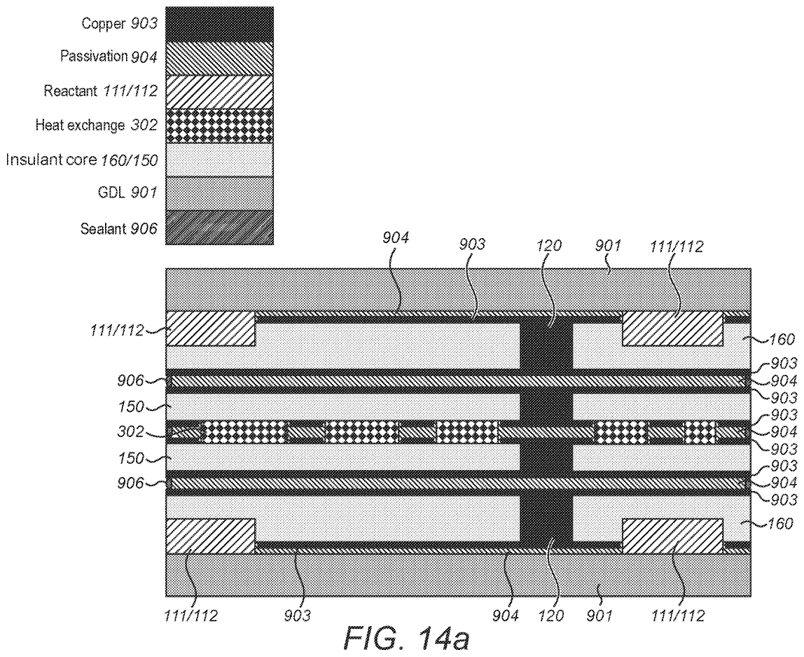

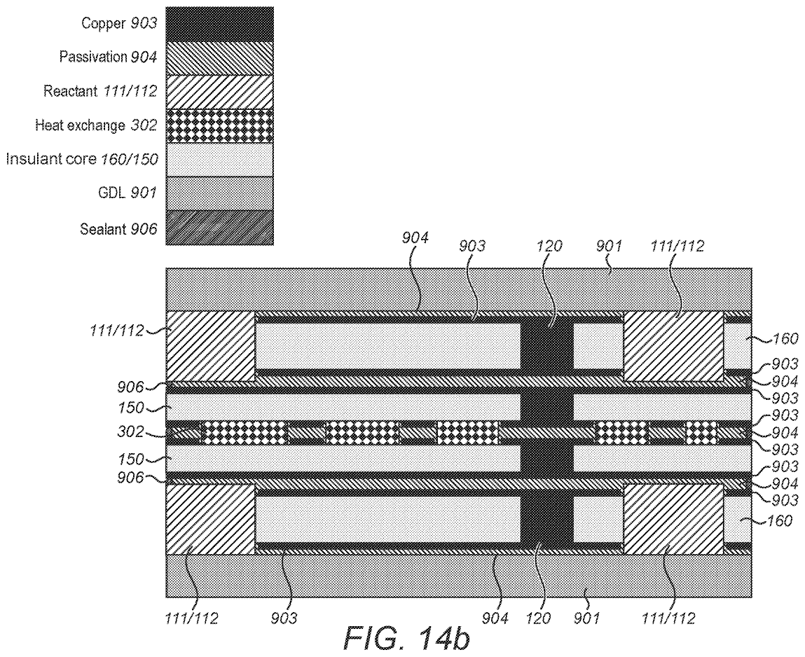

FIG. 14a shows a further embodiment. FIG. 14a shows a schematic representation of how fluid paths or fluid channels may be in the layers/plates described herein. Here, reactant flow paths 111,112 are partial depth, so not through the whole body of the insulating core 160. Reactant flow paths 111,112 are only open to one face/surface of the single insulating core 160 shown here, to the GDL 901 side. Additional layers of insulating material (capping layers) 150 are present between layers 101/102.

Here, the copper 903 and passivation layer 904 layers as part of the capping layers 150 have gaps in them which can act as heat exchange fluid paths 302. The copper 903 and passivation 904 layers could be deposited/plated or otherwise manufactured using techniques known in the art so as to have these gaps, or they could be routed to have these gaps. These gaps, or negative spaces, can be used as heat exchange fluid paths in these embodiments.

The same or overlapping flow path patterns in the copper 903 and layer 904 layers may be found in adjacent boards, so that when boards stacked on top of each other, paths may align to form combined channels. Here the paths are formed from the negative space in the copper 903 and passivation 904 layers of both cap layers 150. These may be termed negative space paths or flow fields, as the paths are formed in the negative space between the two plates. The channels/flow fields are the negative spaces between the boards. This may apply to other embodiments herein, when boards are aligned so flow paths in one layer form a joint flow path. This contrasts to where the channels may be formed in the insulating core themselves.

These arrangements save the need to have a coolant path integrated in the insulating materials themselves. These paths can be created in layers already found on such plates, saving space on other components such as coolant plates. The heat exchange fluid paths 302 can act to control the temperature of the layers either side of the heat exchange flow paths. These copper and passivation layers may already be present, so formation of channels in them does not add any new layers to the boards. These layers may be any conductive material or passivation layer as described herein.

Plated through holes 120, copper layers 903 and passivation layers 904 are all conductive, so current can pass through all of these plates.

Sealant 906 may also be present in this and any embodiment described herein. Sealant between/at the edges of boards can prevent heat exchange fluid leakage and can act to stabilise the stack against slippage of modules in use, for example from vibrations. Sealant is just representative here, and the boards may be wider to have more flow paths than shown.

For all Figures herein, flow paths and board sizes/thicknesses are not to scale and are adjusted just to show how they could be arranged, real thicknesses, sizes and numbers of paths may vary. As shown here, there may be multiple flow paths in a single board.

FIG. 14b shows a further embodiment. FIG. 14b shows a schematic representation of how fluid paths or fluid channels may be in the layers/plates described herein. Here, reactant flow paths 111,112 are shown through the whole body of one of the insulating core 160, as in FIG. 13, with the same effect as for the arrangement shown in FIG. 13 and described there. Capping layers 150 seals flow paths 111/112 of each layer. Copper 903 and passivation 904 layers are also present between layers. Reactant flow channels are through the whole depth of insulating core 160, but also through the copper 903 and passivation layer 904 of this insulating layer. This contrasts with FIG. 14a, where the flow paths 111/112 are not through the whole body of the insulating cores 160 and not through the copper and insulating layers either.

Here, the copper 903 and passivation 904 layers of the capping layers 150 also have gaps in them which can act as heat exchange fluid paths 302, as described for FIG. 14a. These gaps, or negative spaces, can be used as heat exchange fluid paths.

This embodiment is advantageous because having full depth reactant flow fields 111/112 combined with cap layers 150 with heat exchange fluid paths 302 in the negative space created in the layers of the cap layers 150 between insulating layers allows for thinner modules than other embodiments. Insulating core 160 may be thinner in these embodiments, and having the heat exchange fluid paths 302 in the negative spaces means it is not necessary to have heat exchange fluid paths in the insulating cores 160. Manufacture of these is simplified as well as power density increased. Reactant channels may be larger than those for example in FIG. 14a, which may be advantageous.

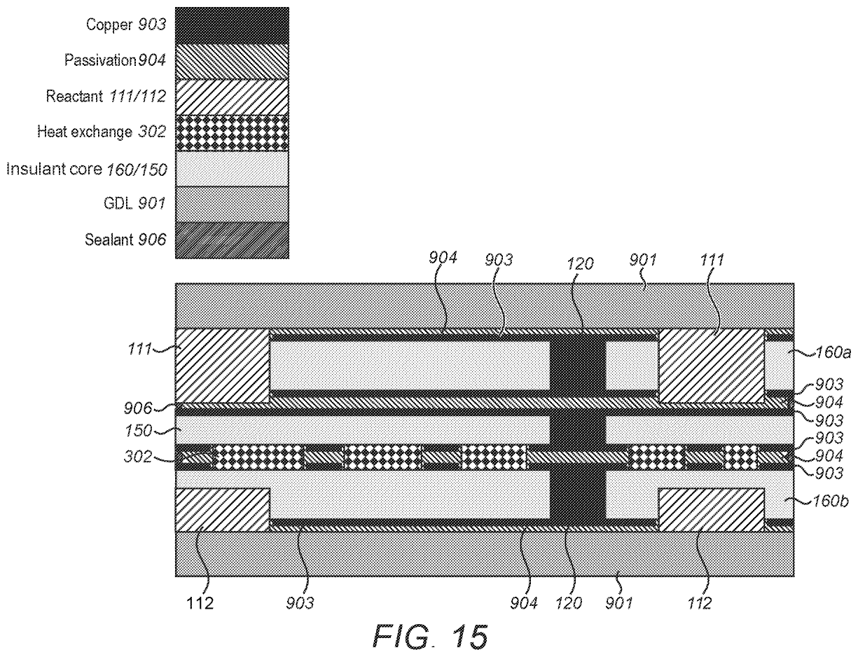

FIG. 15 shows a further embodiment. FIG. 15 shows a schematic representation of how fluid paths or fluid channels may be in the layers/plates described herein. Here an asymmetric arrangement is shown. Cap layer 150 seals reactant channels 111 which are through the whole depth of insulating core 160a. No cap layer is present specifically for core 160b, where reactant channel 112 is at a partial depth of, not through the whole layer. Here, the copper 903 and passivation 904 layers of the outer surface of the capping layer 150 and insulating core 160b also have gaps in them which can act as heat exchange fluid paths 302, as described for FIGS. 14a and 14b. These gaps, or negative spaces, can be used as heat exchange fluid paths. Either side may have the cap layer arrangement, e.g. insulating core 160b sealing channel 112, not 111, this is just a representative embodiment.

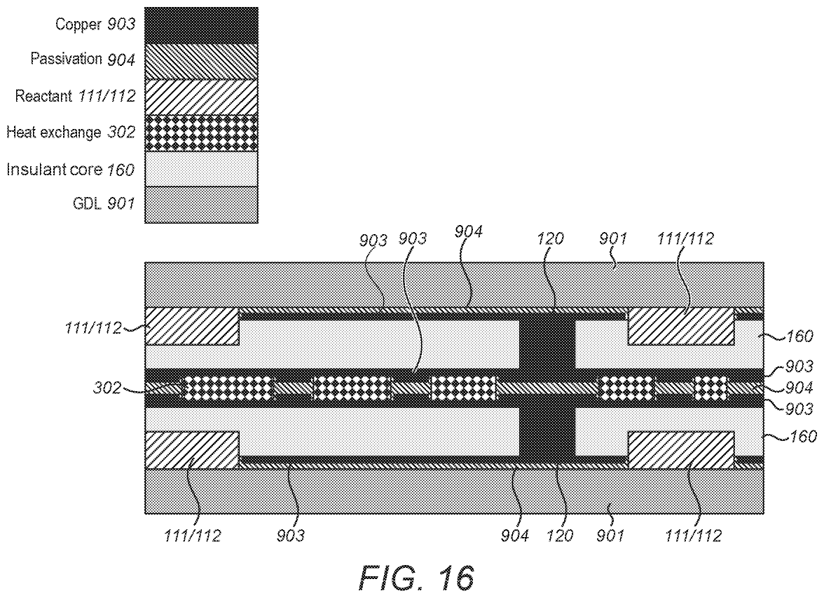

FIG. 16 shows a further embodiment. FIG. 16 shows a schematic representation of how fluid paths or fluid channels may be in the layers/plates described herein. No cap layers are present here, unlike embodiments of FIGS. 14a, 14b and 15. Reactant flow channels 111/112 have a partial depth in each insulating core 160, i.e. not through the whole body of the insulating layer. Here, the copper 903 and passivation 904 layers of the outer surface of the insulating core 160 have gaps in them which can act as heat exchange fluid paths 302, as described for FIGS. 14a, 14b and. These gaps, or negative spaces, can be used as heat exchange fluid paths.

These embodiments may also offer space saving advantages over other embodiments described herein, by using the negative space between fuel cell boards for the heat exchange fluids.

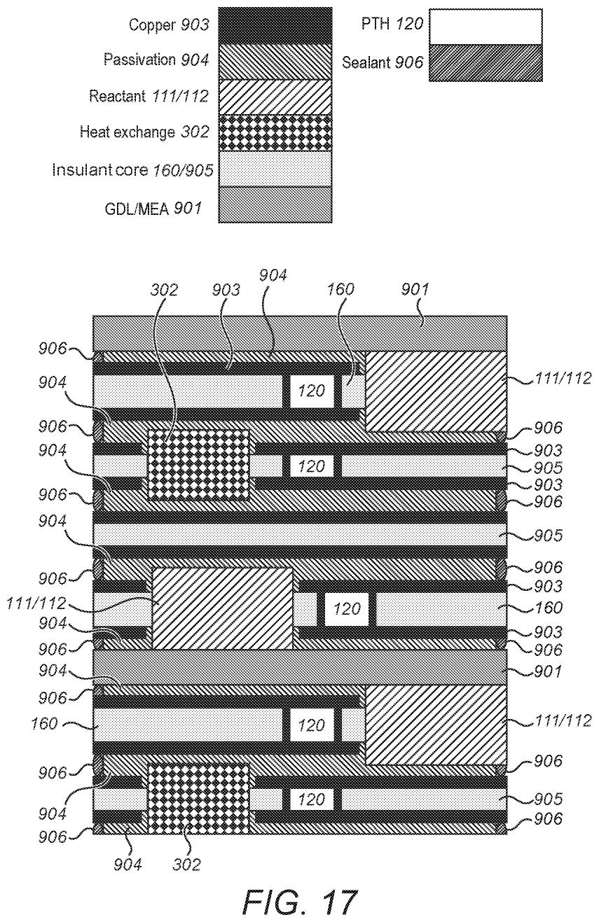

FIG. 17 shows a further embodiment. FIG. 17 shows a schematic representation of how fluid paths or fluid channels may be in the layers/plates described herein. Here 901 represents the GDL layer, structure of this +MEA is not shown as it is not needed. Here reactant channels 111/112 may be deemed to have a greater depth than the insulating core layer 101/102 which they are located in, and also present through/in the copper 903 and passivation 904 layers. The term ‘insulating layer’ used herein may refer to just the insulating core 160 alone, or an insulating core 160 along with conductive material (e.g. copper 903) and passivation 904 layers. These are as described in other arrangements previously. In this embodiment, the heat exchange channels 302 are located in the cap layers 150. These cap layers both act to cap or seal reactant channels 111/112 in the insulating cores 160, but also to have the heat exchange paths 302 as part of them. Plated through holes 120 are located throughout all layers, to carry current and heat through the layers. Here a whole board or module can be seen between two MEA/GDL layers 901, and half another board or module can be seen below a MEA/GDL layer 901.

Here, there is no adhesion or gluing between the layers, just mechanical compression can hold such an arrangement together in operation. Sealant 906 acts to seal, bond or adhere layers together where show. Sealant could be used through such stacks or layers, or just mechanical compression could be used if appropriate.

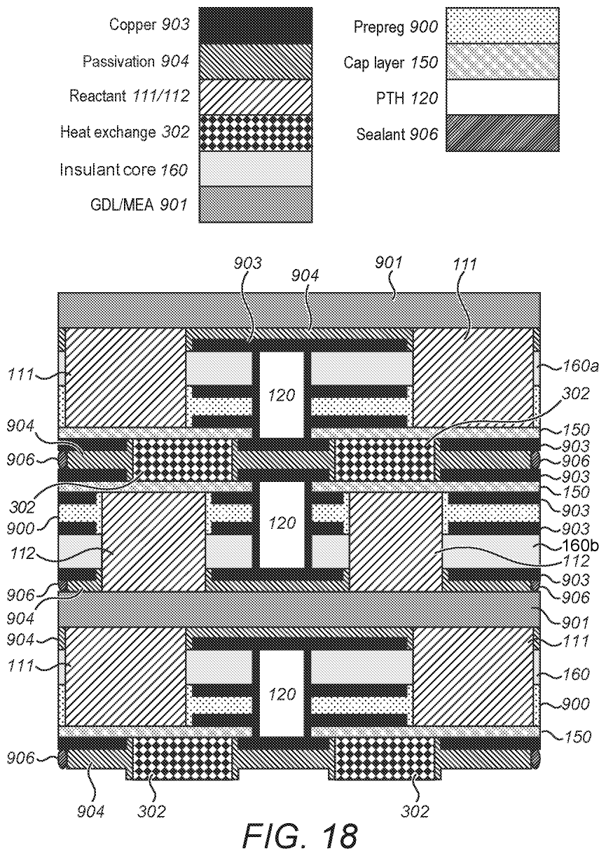

FIG. 18 shows a further embodiment. FIG. 18 shows a schematic representation of how fluid paths or fluid channels may be in the layers/plates described herein. Here reactant channels 111/112 have a greater depth than the insulating cores 160a/160b which they are located in. These are as described in other arrangements previously. Here a whole board or module can be seen between two MEA/GDL layers 901, and half another board or module can be seen below a second MEA/GDL layer 901.

Here cap layers 150 are relatively thin flexible PCB layers. As described earlier, these cap layers are thinner than other potential cap layers, when used they allow for a more compact arrangement with the advantages described herein. Here there is also a layer of prepreg 900 visible, which acts as prepreg is described herein. Prepreg may be present between any and all layers described for all embodiments herein, but not shown in all of the exemplary schematics.

In this embodiment, the heat exchange channels 302 are also located in the negative space created in the copper 903 and passivation 904 layers between the cap layers 105, as described for earlier embodiments.

There is a relatively tight network of copper and passivation layers (which are both electrically and heat conductive) throughout the arrangements of FIGS. 17 and 18, which is effective at transferring heat throughout the layers shown here. Both to and from any heat exchange channels 302 in such an arrangement, allowing for an effective management of temperature in such arrangements. These arrangements have a reduced thickness of fuel cell boards, with space saving, lighter fuel cell boards and increased power density in fuel cell stacks. The location of the heat exchange fluid pathways in the capping layers allows for alternative arrangement to when they are located in the same insulating layers as the reactant fluid paths, for example in FIGS. 10 to 13.

These embodiments and features, for example flow path arrangements, relative depths etc. may also apply to the component for an electrochemical device described herein.

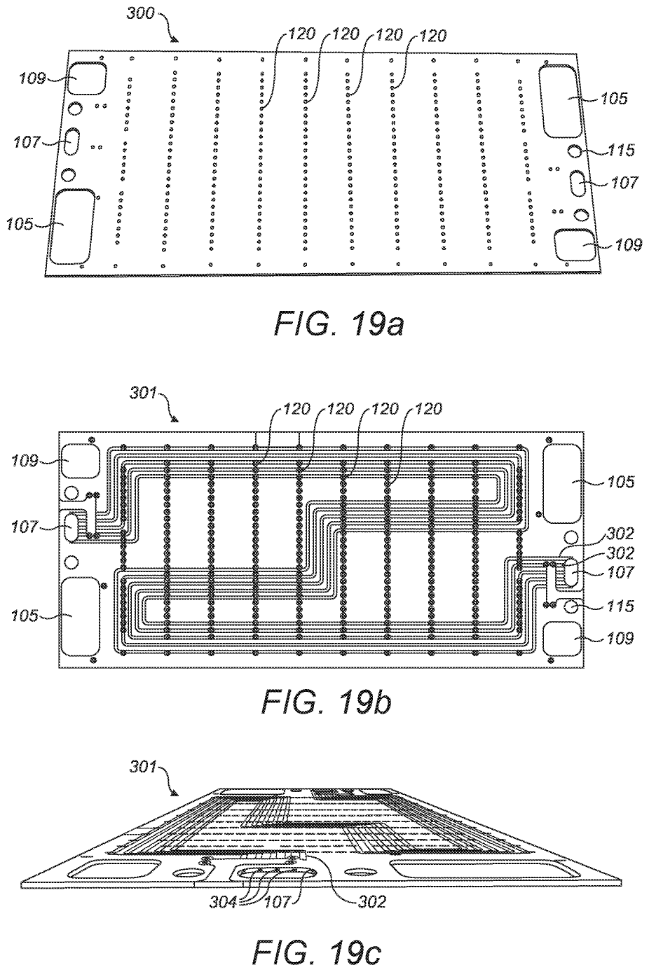

FIG. 19a shows one side of a further means 300 to control the temperature of a fuel cell board or adjacent fuel cell boards to this means. This may be a heat exchange plate or layer, a thermal management plate or layer, a coolant plate or liquid coolant plate. Cathode manifold 105, heat exchange fluid manifold 107, anode manifold 109 are all labelled. These manifolds line up with the equivalent manifolds on a fuel cell board (e.g. 200 or 201 visible earlier). The thermal management plate also has holes 115 drilled or routed for bolting holes.

The heat exchange plate 300 is made of two PCB layers. FIG. 19b shows one of these two PCB layers 301, with inner face 301a shown. This is the thicker of the two PCB layers which together make up the heat exchange plate 300. Although this layer does not necessarily need to be thicker, here it is. Because it is copper plated and there are plated through holes 120 through the body of the plate, heat exchange plate 300 is conductive, acting as a bipolar plate between the adjacent cathode plates 101 and anode plates 102 of adjacent fuel cell boards 200. Plated through holes 120 are drilled around the flow fields 302 to provide conductive paths from one side of the plate 300 to the other. These enable electrical connection between anodes and cathodes of adjacent fuel cell boards. 4 exemplary plated through holes 120 are labelled, but ten rows of these can be seen along the heat exchange plate 300. In a multi-fuel cell board fuel cell stack of this embodiment the anode plates of one fuel cell board will be facing the cathode plate of the adjacent fuel cell board, and vice versa.

Flow fields 302 are routed into the inner face 301a of PCB layer 301, two of the 5 visible heat exchange flow fields of plate 300 are labelled. Layer 301 is bonded to a featureless second layer (not visible separately in FIGS. 19a-19c) which seals the flow fields 302 so that heat exchange fluid entry/exit to/from the flow fields is only possible at the plate edge, as visible in FIG. 19c.

FIG. 19c shows a side profile of board 301 of heat exchange plate 300 showing just the PCB layer 301 with the flow fields, with one of the heat exchange fluid flow fields 302 labelled of the 4 visible. Flow field input/output holes 304 are visible, with three of the 5 holes labelled. Equivalent input/output holes 304 are also found at the opposing ends of flow fields 302. Heat exchange fluid is supplied and leaves through these holes 304 into/out of to heat exchange fluid flow fields 104 from/to heat exchange fluid manifold 107. In operation, heat exchange fluid will be pumped into one side of the plate and will flow through the flow fields and out of the other side of the plate.

The heat exchange plate is linked to a means to supply a heat exchange fluid to the plate. This can involve, for example, a heat exchange fluid being circulated around a loop which requires a pump, a radiator and a stack fluid circuit (analogous to a car engine cooling loop with the stack replacing the engine). There can also be a small reservoir of fluid to account for small fluid losses over time. The fluid is stored in the reservoir and throughout the fluid circuit. The circuit can take heat from the stack, dissipate it through the radiator (which is assisted by a fan to dissipate the heat to the atmosphere), and the fluid can be is moved continuously by the pump during operation. Alternatively, the circuit can add heat to the stack, taking heat from a warmer part of the circuit.

As well as acting as a conductive plate between the adjacent cathode plates 101 and anode plates 102 of adjacent fuel cell boards 200, heat exchange plates 300 act to control the temperature the fuel cell boards either side of the plate 300. Plates may extract heat or add heat from other parts of the stack via the fluid that flows through the fluid paths in the plate 300.

Reference herein to “heat exchange fluid”, “thermal management fluid” or a “temperature control fluid”, interchangeable herein, refers to a fluid which can be used in a fuel cell or a component for a fuel cell or other such electrochemical device which can flow near or flow adjacent or flow to contact one or more portions of the fuel cell boards, fuel cells, components for fuel cells or fuel cell stacks described herein. For example, the systems and methods herein can allow a heat exchange fluid to flow through a flow path adjacent or near the anodes of a fuel cell board, acting to cool or heat those anodes. These can act to cool components, for example cool anodes of a fuel cell whilst the fuel cell functions. Or, such heat exchange fluids can act to heat or warm components, for example to heat up an anode component of a fuel cell at the point of fuel cell start up, early in a fuel cell operation timeline/program or in low temperature environments. Heat exchange fluids can be liquids, gases or other such suitable fluids as described herein. Heat or temperature can be added or removed from various parts of the fuel cell boards, fuel cells, components for fuel cells or fuel cell stacks described herein.

The heat exchange fluid may contact one or more portions of the fuel cell boards, fuel cells, components for fuel cells or fuel cell stacks described herein. For example, the systems and methods herein can allow a heat exchange fluid to flow through a flow path adjacent or near the anodes of a fuel cell board, acting to cool those anodes.

Thermal management or heat exchange may be to maintain the fuel cell board or stack at a certain operating temperature, to operate the system in a more energy efficient manner, to increase the operating lifetime of the system, and/or to provide more efficient fuel cell operation (e.g. allowing a fuel cell to operate within set parameters, not leading to over production or under production of power).

All heat exchange fluids known to those of skill in the art would be suitable for the purposes of thermally managing or controlling the temperature of fuel cell boards, fuel cells, components for fuel cells or fuel cell stacks described herein.

Particularly, heat exchange fluids can be deionised water, water, or a mixture of water or deionised water and glycol to prevent freezing of the water can be used. Other suitable heat exchange fluids are envisioned, and would be known to a person of skill in the art. For example, a fluid with a ratio of 1:1 deionised water to glycol (such as ethylene glycol or propylene glycol) may be used, or alternatively a ratio of 2:1 deionised water to glycol, or alternatively a ratio of 3:1 deionised water to glycol, or alternatively a ratio of 4:1 deionised water to glycol, or alternatively a ratio of 5:1 deionised water to glycol. A solution may be up to 10% glycol in deionised water, or 1% glycol in deionised water, or 2% glycol in deionised water, or 5% glycol in deionised water, or 10% glycol in deionised water, or 20% glycol in deionised water, or 30% glycol in deionised water, or 40% glycol in deionised water, or 50% glycol in deionised water. Or, a heat exchange fluid may be a mixture of another type of alcohol (for example, methanol, ethanol, isopropyl alcohol) and deionised water. A solution may be up to 10% alcohol in deionised water, or 1% alcohol in deionised water, or 2% alcohol in deionised water, or 5% alcohol in deionised water, or 10% alcohol in deionised water, or 20% alcohol in deionised water, or 30% alcohol in deionised water, or 40% alcohol in deionised water, or 50% alcohol in deionised water. Coolant fluid may also comprise one or more perfluoroamines, such as Fluorinert.

Insulating layers, within a single insulating layer, could have multiple different fluid paths, or channels, of different sizes, shapes and/or dimensions, or fluids at different flow rates or different fluid temperatures. Fluids could be at different temperatures or different flow rates in different plates, or at different temperatures or at different flow rates in different flow paths within the same plate. When multiple thermal management plates are present in a fuel cell stack, each plate may have different fluid paths, different sized, shaped or dimensioned fluid paths or be designed to carry different fluids. Different plates could carry different temperature fluids, or fluids with different flow rates, depending on varying thermal management fluid need throughout the stack.

Overheating of the fuel cell stack can cause problems and cooling of stacks is typically required. This is generally achieved by supplying a heat exchange fluid, for example a coolant fluid (e.g. air or water or a water/glycol mix) that circulates within the stack. Heat exchange and reactant fluids are typically supplied to the cathode in the same channel or flow. However, in all embodiments described herein, the heat exchange fluid is not part of the same flow as the “reactant” to the cathodes (typically cathode reactant is air, so air is the coolant as well as the cathode reactant). This separation of the heat exchange fluid from cathode reactant is advantageous as it provides more control over the flow of reactant to the cathodes, the rate of which will not be determined by the rate of a cooling airflow needed. It also allows improved control of cooling of the anodes.

Fuel cell stacks can also encounter problems of being at too low a temperature for optimum operation, for example at start-up or in colder environments. A fluid with the purpose of heating or increasing the temperature of various parts of the fuel cell boards, fuel cells, components for fuel cells or fuel cell stacks described herein can also be supplied in the same manner as a coolant. This can be in the fluid management plates described herein, or the channels described in the anode or cathode plates described herein.

In some embodiments, the same fluid that will later cool the various parts of the fuel cell boards, fuel cells, components for fuel cells or fuel cell stacks described herein may also act to initially heat or increase the temperature of the various parts of the fuel cell boards, fuel cells, components for fuel cells or fuel cell stacks described herein. This could be for example when the stack is colder at start-up, the circulating fluid will act to warm the components it is supplied to or past as it is at a higher temperature than the fuel cell boards. Later, the same fluid will now act to cool the components it is supplied to or past as it is at a lower temperature than the fuel cell boards.

Using a heat exchange plate and a separate reactant source for the cathodes, i.e. not air pumped in from the atmosphere is especially advantageous for fuel cell stacks that operate at relatively higher energy densities. An increased energy density leads to an increased dissipation of heat, so a more efficient hear transfer means can be utilised. For example, a fluid with a higher heat capacity than air (i.e. water or a mixture of glycol and water) may be used as it has the ability to take the heat away from the stack.

A heat exchange plate may be laminated with or held compressed to the fuel cell board, but to the anode side of the fuel cell board (i.e. the second PCB layer, adjacent to the anode side of the MEA). This is for heat exchange plates with just one PCB layer, i.e. PCB layer 301 with heat exchange fluid flow fields 302. Lamination of the heat exchange plate to the fuel cell board may allow increased energy density compared to a two layer heat exchange plate, because in this coolant plate there is just one layer of PCB. Further, sealing the coolant plate to the fuel cell board simplifies assembly of the fuel cell stacks, due to there being fewer components and fewer non-built in seals to the stack. This can be termed a Fluid Plate Module, and can comprises an anode plate (first PCB layer) cathode plate (second PCB layer), MEA and a heat exchange plate all in a single board, plate, module or assembly. A plurality of these can form a fuel cell stack, as described herein.

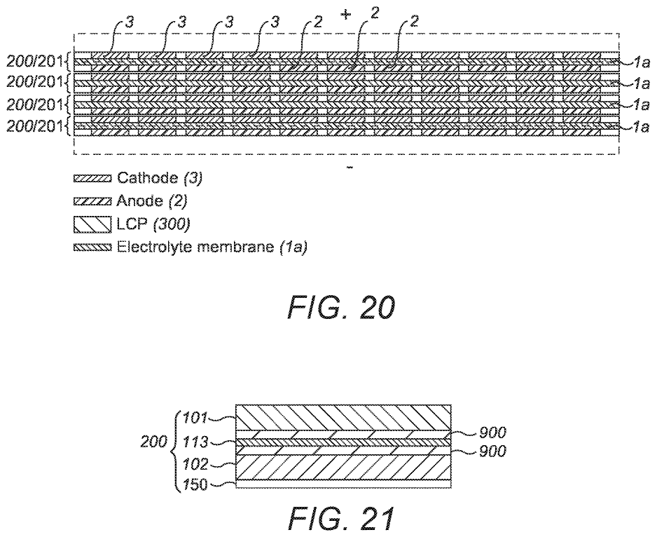

FIG. 20 shows a schematic of a fuel cell stack of this embodiment. Four fuel cell boards 200/201 are shown, four single cell plates 200/201, four boards connected in series. Cathode plates 101 and anode plates 102 are not separately shown in FIG. 20 but one of each is present in each fuel cell board 200 as described above (there would be four of each in a stack this size). In FIG. 20 three thermal no heat exchange plates are shown, because the heat exchange fluid pathways are present in one or of both or the cathode and anode layers, as described herein.

In FIG. 20 Anodes 2 and cathodes 3 are shown, three of each are labelled in FIG. 20, each fuel cell board 200 has 11 anodes 2 and 11 cathodes 3 arranged in horizontal planes of only anodes 2 and only cathodes 3 in each horizontal plane. Anodes 2 are disposed opposite cathodes 3, with a single electrolyte membrane 1a between anodes 2 and cathodes 3. The layout of the anodes and cathodes in this embodiment is similar to that of a traditional fuel cell, because there is a single electrode in a plane. In typical bipolar fuel cells an MEA is sandwiched between bipolar plates to give a single cell at each layer. Bipolar plates are typically made with electrically conductive materials such as graphite or metals. Here, uniquely, traditional bipolar plates are not necessary, because plated through holes and copper plating on the anode and cathode plates. Not shown are the plated through holes through the cathode plates 101 and anode plates 102 which electrically connect anodes 2 and cathodes 3 to those on an adjacent board. In this embodiment, there are no plated through holes though the electrolyte 1a. By virtue of the copper plating and plated through holes, current does not need to cross the electrolyte layer, but moves laterally from anode to cathode parallel to the horizontal plane of electrodes. Consequently, no through-membrane connections are necessary for the current to flow.

FIG. 21 shows a simplified construction schematic of a board of the present embodiment. Fuel cell boards are constructed by layering up of MEAs, insulating layers and an epoxy resin prepreg (herein ‘prepreg’). In construction of a fuel cell board 200 of this embodiment, the MEA 113 is sandwiched between two layers of prepreg 900, then the cathode and anode plates 101, 102 are laminated either side of those two layers of prepreg 900. These layers are laminated all together. Plated through holes 120 are then drilled into the anode 102 and cathode plates 101. After this is complete the final drills and routes expose the anode flow fields and cathode flow fields as well as drills for gas manifolding, bolting holes, and alignment pins can be made.

Use of a sealing materials such as prepreg, and the use of insulating plates, such as PCBs ensures that the MEA is sealed from anything not deliberately directed to the components of the MEA by the channels in the boards (e.g. anode and cathode plates) directly adjacent to the MEAs. This is an advantage of the herein described technology, it allows quick, simple and cheap construction of such structures. Use of lamination with for example an epoxy resin prepreg also maintains compression of the gas diffusion layer of the MEAs, an important component in maintaining fuel cell performance, providing a sufficiently low resistance electrical path without compromising distribution of reactant fluids.

Boards which are laminated with a specific lamination process, involving careful pre-cutting and alignment of materials, along with bespoke heating, cooling, pressure and washing cycles.

Boards or layers of boards may also be mechanically compressed or pressed together by suitable means. This may be when a whole fuel cell stack is compressed together. This means lamination may not be required in all embodiments. This can be with the use of layers of prepreg or other sealant type materials.

Once fuel cell boards 200 of this embodiment are constructed, they can be made into fuel cell stacks. These are modular and made of two components, the fuel cell boards 200 and the thermal management plates 300. Stacks begin and terminate with an endplate which provides compression through the stack as well as sealed ports to connect fuel, oxidant, and thermal management fluid. Means to remove excess current can also be used at either end of the stack to take off the significantly high current when necessary. A stack can be built with a repetitive sequence of and fuel cell boards 200, with possible addition of heat exchange plates 300. The stacks shown throughout may be held together with bolts, or compression bands, which also provide compression for the seals between modules, however any means to hold stacks together compressed, or any means to seal fuel cell boards, possible heat exchange plates, or modules together, and end plate types known in the art, may be utilised. Gaskets to seal manifolds or other parts of the fuel cell stack together can be used, if necessary, but may not be necessary in such a stack.

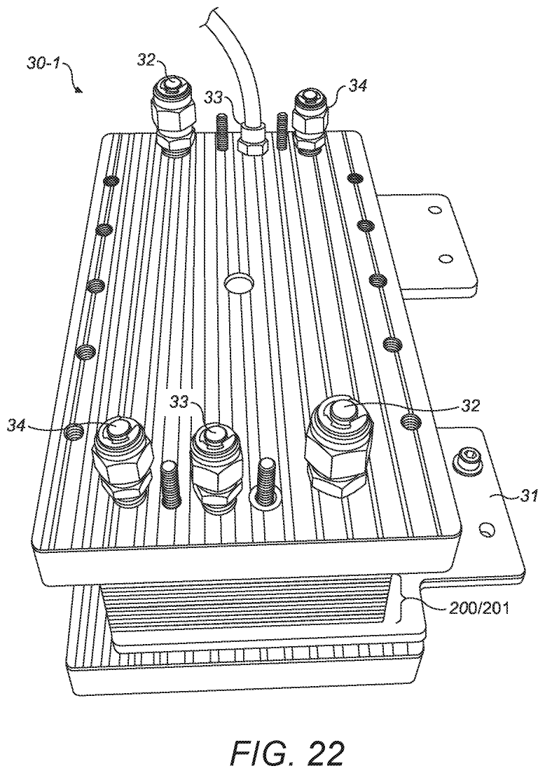

A fuel cell stack 30-1 of the of an embodiment is shown in FIG. 22. The fuel cell stack 30-1 is encased in a fuel cell casing with end plate 31 visible. Present in this embodiment are 12 fuel cell boards 200. As shown in FIG. 22, the fuel cell has two cathode inlet/outlets 32, two heat exchange fluid inlet/outlets 33 and two anode inlets/outlets 34.

Cathode inlets 32 will be connected to a compressed air compressed air canister or an air compressor to supply compressed air to act as an oxidant to react at the cathodes in fuel cell operation. Cathode outlets 32 will be connected to an exhaust to the atmosphere. Sometimes cathode outlets 32 will be connected to an exhaust via a humidifier such that the water produced in the fuel cell can be used to humidify the air going into the stack. This is achieved via passing the incoming and outgoing fluids over a water permeable membrane.

Anode inlets 34 will be connected to a hydrogen cannister, to supply hydrogen reactant to the anodes to act as a reductant gas in order to fuel the fuel cell operation. Anode outlets 34 will be connected to an exhaust to the atmosphere or an anode recirculation system.

An anode recirculation system can comprise a water trap (to remove accumulated water) and a hydrogen pump or orifice which increases pressure such that any unused hydrogen can be put back into the stack.

Endplates 32 act to compress the fuel cell and to seal it, to prevent any fluid leakage in operation. Fuel cells are bolted together to ensure compression.

Herein the construction of the fuel cell boards and the fuel cell stack is described herein in terms of ‘horizontal’ and ‘vertical’ planes, in accordance with the embodiments illustrated in the Figures. However, these terms are used for clarity only, and are not limiting on the scope of the invention. It will be clear to the reader that the fuel cell boards can be arranged in any plane, not just the horizontal plane. Further, the term ‘directly opposite’ is not limited to the electrodes being in register. The anode lies on one face of the polymer electrolyte and lies directly opposite a cathode on the opposite face of the same electrolyte membrane layer.

Reference herein to “fuel cell boards” or a “fuel cell board” refers to a membrane electrode assembly (MEA) 113 sandwiched between and a cathode plate 101 and an anode plate 102. In the present embodiments, the three layers may be laminated together, or compressed together. Some fuel cell boards may have a cap layer 150 also as part of the structure. Fuel cell boards may also be referred to as fuel cell modules herein. The use of ‘fuel cell board’ is not intended to limit the size, shape or arrangement of the MEA, or other components of the board. Fuel cell board is not intended to be limiting on the size, shape or dimensions of the board, it is just a term in the art to refer to the MEAs and plates described herein.

The fuel cells, fuel cell boards and components may be constructed of insulating layers, for example Printed Circuit Boards (PCB). Individual layers can be adhered together into a solid structure using an epoxy-containing glass fibre composite (“prepeg”). The MEAs may be laser bonded onto a insulating layer and then to create the fuel cell board, a plurality of boards are laminated together. The gaps between the electrodes, and the sealing achieved in these gaps by the epoxy resin, prevent separate flows from mixing, i.e. prevent air cooling, reactant and fuel flows from mixing. A simple PCB can also be used as the end board or plates in the stacks described herein.

The term ‘insulating layer’ used herein may refer to an insulating core alone, or an insulating core along with conductive material and passivation layers. The insulating layers of the embodiments herein can be printed circuit boards (PCBs). PCBs for the embodiments may be produced in the known way. Reference herein to ‘Printed Circuit Board(s)’ or ‘PCB(s)’ refers to one or more layers of insulating material comprise of one or more dielectric substrates such as an epoxy resin, for example FR-1, FR-2, FR-3, FR-4, FR-5, FR-6, CEM-1, CEM-2, CEM-3, CEM-4, CEM-5, polytetrafluoroethylene, and G-10, preferably the insulating layer comprises FR-4. Multiple layers or boards may be laminated together, for example with an epoxy resin prepreg. Plates or boards may comprise one or more layers of these insulating materials, or one or more PCB boards may make up a single ‘insulating layer’ as referred to herein. PCB boards comprise areas of conductive material plating. In order to yield conductive areas, a thin layer of a conducting material (for example a metal, for example copper) may either be deposited, plated or applied to the whole insulating substrate and etched away (for example using a mask) to give a desired conductive pattern. Conductive material may be applied by electroplating. The PCBs described throughout may or may not be copper plated in various parts across the PCB boards. The insulating layers, e.g. PCBs, may be flexible PCB, for example the thinner end of the thickness ranges described in Table 1 above.

A means to conduct electrical current from one face of a plate or board to the other is necessary, for example “plated through holes” (PTHs) or conductive material filled through holes. This is because the plates and boards described herein comprise an electrically insulating material so such a means must be introduced so that copper faces either side of an insulating layer can become electrically conductive and a current can pass from the MEAs to electrical connections elsewhere in the fuel cell, so electrical power can be outputted from the fuel cell.

The “means to conduct electricity” as referred to herein may be plated through holes or conductive material filled through holes. “Plated through holes” (PTHs) are holes that form a conduit through one or more insulating material layers, said conduit running substantially perpendicular to the planar surfaces of the fuel cell boards. These are plated with a conductive material, for example copper, to act as a conduit for electricity. The Plated though holes are necessary because insulating material (e.g. FR-4) is electrically insulative in its core so PTHs must be introduced so that electricity can pass from one face of a layer to another, if desired. These may be formed by holes bring drilled through the layer of insulating material (for example a PCB plate) and then lining with a conductive material. For example, they may be lined with a conductive material by an electroplating dip process such that copper lines the edge of each hole. Optional additional steps can occur after electroplating, wherein i) resin can be used fill the remainder of the hole, which is achieved by forcing resin over the PCB layer such that it flows through any holes present; ii) electroplating dip processing again such that the resin filled holes are capped with copper on both sides; and iii) there may be a mild milling process after this to ensure the surface of the PCB is flat. When these are found through PCB layers they can create continuity between two layers of copper plating on either side of the PCBPTHs may be formed through only certain layers of the insulating materials described herein, or through only some layers of the fuel cell boards described herein (for example through just the anode and cathode plates, to be able to carry current to/from the anode/cathode to the outer surface of a layer of insulating material). PTHs may be formed through the whole fuel cell board (for example through both the anode and cathode plate with the same hole, to be able to carry current to/from one surface of the fuel cell board to the other surface of the fuel cell board). Holes filled with a conductive material such as resin or copper may be used in place of or in addition to PTHs. Insulating layers may also not have means to conduct material through the body of the layer.

In some embodiments, to deposit through-membrane electrical connectors, a metal or other electrically conductive material is chemically deposited within the membrane. The material is preferably chemically stable within the membrane under fuel cell operating conditions, and may typically be a precious metal (e.g. Pt, Au, Ru, Ir, Rh, Pd) or an oxide of a precious metal. Various approaches for depositing conductive bands in the membrane are described in WO2012/117035, the content of which is incorporated herein by reference.

Fuel cell boards can have a single layer of anode and cathode, or a MEA layer (/fuel cell board) may have multiple anode-cathode pairs. The present techniques can be applied to a fuel cell comprising one or more fuel cell boards each having a single anode-cathode pair, or applied to a fuel cell comprising one or more fuel cell boards comprising multiple anode-cathode pairs on each board.

Anodes can be designed to be aid in the hydrogen oxidation reaction (HOR), be robust to degradation (thermal cycling, voltage, acidic environment), and have a high electrochemically active surface areas (ECSA). The same applies for cathode but for the oxygen reduction reaction (ORR).

Anodes and cathodes may comprise platinum with a carbon support. Other platinum group metals can be used (Pt, Ir, Os, Pa, Rh, Ru, Pd) as well as non precious metals (NPMs) which have much lower electrochemical activity such as Ni, Fe, Co, Sn).

These could vary by ionomer content, PTFE content, catalyst content, composition of the electrodes of by varying the coatings on the electrodes.

The materials that the anodes and/or the cathodes themselves are made of may vary. This could be by changing the material the electrodes are made of, i.e. they could be made of graphite, Pt, Ir, a mixture of these or of different mixes or materials across the face of a fuel cell board. For example the % of platinum in graphite electrodes might vary across a fuel cell board to account for variation in condition across the fuel cell board.

The additive materials provided to or with the anodes and/or the cathodes may vary. This could be by addition of IrOx, PTFE, Ru, in varying concentrations across a fuel cell board.

In some embodiments, a catalyst layer on the electrodes accelerates a reaction with the fuel (on the anode electrode) and oxidant (on the cathode electrode) to create or consume the ions and electrons. This layer may be made of suitable catalytic material for the reactions of interest, as is commonly understood by a person skilled in the art of fuel cell production. For example, the catalyst layer may be composed of platinum nanoparticles deposited on carbon and bound with a proton conducting polymer (e.g. Nafion™).

MEAs may also comprise one or more gas diffusion layers (GDLs). These may be porous carbon papers such as Sigracet (SGL Carbon), Avcarb, or Toray. These can also be metallic foams or porous metallic materials (e.g. foams or felts). These may comprise aluminium, titanium or stainless steel.

The electrolyte membrane may be a proton-exchange membrane (PEMFC), also known as polymer electrolyte membrane (PEM). This may be fluorinated (for example a sulfonated tetrafluoroethylene based fluoropolymer-copolymer, e.g. Nafion™) or a not fluorinated membrane (for example a hydrocarbon membrane, e.g. an Ionomr PEMION™ membrane). The membrane may be Ionomr Pemion, GORE-Select membrane or a Fumatech Fumapem membrane. Or, the electrolyte membrane may be an anion exchange membrane (for example a Fumatech Fumasep FAA-3 membrane). Other such suitable membranes known in the art may be used with the embodiments herein.

The reactant fluid may be oxygen gas, air or pressurised air or any other suitable fluid which would be oxidised at the cathodes. As described above, the reactant fluid for the cathodes may be air draw in from the atmosphere outside the fuel cell by means of a fan or air compression device.

The construction of fuel cells from PCBs and their advantages are further described in WO2012/117035 and WO2013/164639, which are incorporated herein by reference.

Reference herein to a passivating or passivation layer means an additional layer deposited on the copper or other conductive metal layer. A passivation lay may be a passivation ink, which may refer to a conductive ink, particularly the ink may have a functional conductive element that is carbon based. The ink acts to provide a low through-plane resistance conductive path between the electrode and the current collector while protecting the copper from the corrosive environment of the fuel cell. It does this by passivation any migratory copper which would otherwise cause irreversible damage of the electrolyte/membrane. Further, the ink may be a carbon ink, it may be a silver paste and polyurethane based ink with conductive elements dispersed in it such as carbon nanotubes or gold/silver nanoparticles these and other inks will be known to a person of skill in the art. A passivation layer may comprise gold, silver or nickel, and/or may be an electroless nickel immersion gold (ENIG) layer, an organic solderability preservative layer or an immersion silver plating layer, or any other passivation treatment known in the art. When channels are formed in copper on insulating layers, the manufacturing steps may consist of first etching away the conductive martial (e.g. copper), then depositing a passivation layer which will only be deposited on the conductive martial (e.g. copper).

In operation, the fuel cell is enclosed in a housing and is sealed from the atmosphere. Reactants are fed into the fuel cell channels through sealed connections. Seals may, for example, be made of PDMS. In particular, fuel (e.g. H2) and oxidant (e.g. O2) are fed into appropriate channels of the fuel cell stack, with fuel being supplied to the anodes and oxidant to the cathodes. The electrical current thus formed can be taken directly or the output of the fuel cell board can be modulated utilising the aforementioned switch. A constant power output of the stack may be achieved in a variety of ways. For example, all fuel cell boards may be loaded at all times. Alternatively, the fuel cell boards may be divided into groups and these groups may be “switched on” in turn in a synchronous manner (i.e. switching occurs at a defined time for all fuel cell boards). The fuel cell boards may also be switched in an asynchronous or quasi-asynchronous manner—i.e. each fuel cell board is connected and disconnected to the load for a defined period and frequency individually specified for each fuel cell board. By switching the fuel cell boards so that they are only connected to the load for a proportion of the time according to a duty cycle, the output power of the stack can be continuously modified. For example, if over a given sample period of time only 50% of the fuel cell boards are connected to the load, then the output power of the fuel cell stack will be similarly reduced. The manner in which this 50% is achieved may be brought about in a multitude of ways—for example half of the fuel cell boards may be disconnected from the load and half connected for the entire period; alternatively all fuel cell boards may be connected to the load, but each connected for only half of the sample period. Alternatively, half of the fuel cell boards may be connected to the load for one quarter of the sample period, and the other half for three quarters of the sample period etc. The choice of the specific scheme or duty cycle used may depend on the performance of individual fuel cell boards, the need to avoid localized heating or ‘hot spots’, the need to avoid flooding of cathode sites with product water, the need to prevent dehydration of the membrane, or the need to counteract poisoning of the electrodes. It will be noted that the duty cycle may be predetermined or may be controlled in real time based on monitored performance of the fuel cell, for example in a closed feedback loop with the voltage measuring apparatus described above. Part-time use of fuel cell boards may also improve efficiency as one can achieve optimum load conditions and power conversion for each individual fuel cell board rather than for the fuel cell stack which is a limitation of current designs. By including additional switching and filtering components on the fuel cell boards, a smoothly varying output, for example a sinusoidal wave, may be obtained, in addition to simple “changeovers” or steps from one potential to another.

If, for example, an electrode is underperforming or has become faulty, it is not only possible to switch out the affected board using the individual electronics, but it is also possible to stop the fuel or oxidant supply to specific electrodes.

It will be appreciated that aspects of the invention can be interchanged or juxtaposed as appropriate. The fuel used is not restricted to hydrogen, but may be any suitable fuel. For example, the new geometry fuel cell stack described herein is also applicable to methanol used in Direct Methanol fuel cells.

Although the invention as exemplified uses hydrogen as the reactant fuel (i.e. the reductant gas for the anodes), the fuel cells could be used with all suitable pressurised fluids. As used herein “fluid” refers to a substance that has no fixed shape and yields easily to external pressure, for example a gas or a liquid. Fuels for use with the systems and methods as described herein are fluids. These fuels can be hydrogen or a hydrogen-containing mixture, or a hydrocarbon or hydrocarbon derivative. Fuels could be other gaseous fuels, such as methane or propane. Fuels could be other gaseous fuels, such as methane or propane and fluids include oxidants such as air and oxygen.

The fuel cells and fuel cell boards described herein can be capable of, any envisioned power output for a fuel cell stack. Each fuel cell board may have a power rating of at least 100 W. Each fuel cell board may have a power rating of up to 1000 W. Each fuel cell board may have a power rating of 10 W to 1000 W. A fuel cell comprising multiple fuel cell boards may have a power rating of at least 10 kW. Preferably, each fuel cell comprising multiple fuel cell boards may have a power rating of up to 1000 kW. Preferably, each fuel cell comprising multiple fuel cell boards may have a power rating of 10 kW to 1000 kW. But, any power rating is merely representative of current embodiments, and the rating may vary from these described as just exemplary.

The systems and methods can be used with pressurised fuel storage units or containers, as are well known in the art. The fuel can be stored in a pressurised storage unit, for example a bottle or canister. These can be, for example at a pressure of between 700 and 300 bar.

An aspect of the present invention is a component for an electrochemical device. The component may comprise any of the features described herein related to the insulating layers for the fuel cell boards. It may comprise an insulating layer comprising at least one first fluid path on one face of the insulating layer and a second fluid path for a heat exchange fluid on the other face of the insulating layer.

This may be a component for any type of electrochemical device where fluid flow control is important, and it would be advantageous to utilise heat exchange fluid flow in such a device. For example, this might be for a fuel cell as described herein. Or, this could be for an electrolyser or other such electrochemical device.

It will be clear to one skilled in the art that many improvements and modifications can be made to the foregoing exemplary embodiments without departing from the scope of the present disclosure.

1. A fuel cell comprising:
at least one fuel cell board, wherein the fuel cell board comprises:
i) a Membrane Electrode Assembly (MEA) comprising at least one ion permeable membrane, at least one anode, and at least one cathode, wherein the one or more anodes are arranged on a first surface of the ion permeable membrane and the one or more cathodes are arranged on a second surface of the ion permeable membrane
ii) a first insulating layer comprising at least one first fluid path; and
iii) a second insulating layer comprising at least one second fluid path;
wherein the MEA is located between the first insulating layer and the second insulating layer so that the at least one first fluid path is arranged such that an oxidant fluid can flow to the one or more cathodes of the at least one fuel cell board and so that the at least one second fluid path is arranged such that a reductant fluid can flow to the one or more anodes of the at least one fuel cell board;
wherein the fuel cell board comprises at least one third fluid path for a heat exchange fluid.

2. The fuel cell of claim 1, wherein the second insulating layer comprises the at least one third fluid path for a heat exchange fluid, and the at least one third fluid path is arranged so that the heat exchange fluid can control the temperature of the fuel cell board, preferably the temperature of the at least one anode, and/or
wherein the first insulating layer comprises the at least one third fluid path for a heat exchange fluid or a further/fourth fluid path for a heat exchange fluid, arranged to control the temperature of the fuel cell board, preferably at least the temperature of the at least one anode of an adjacent fuel cell board.

3. The fuel cell of claim 1, wherein the fuel cell comprises a plurality of the at least one fuel cell board,
wherein each of the plurality of fuel cell boards is arranged such that the first insulating layer and the one or more cathodes of each fuel cell board face the second insulating layer and the one or more anodes of an adjacent fuel cell board; and/or
wherein each of the plurality of fuel cell boards is arranged such that the second insulating layer and the one or more anodes of each fuel cell board face the first insulating layer and the one or more cathodes of an adjacent fuel cell board.

4. The fuel cell of claim 3, wherein the first layer further comprises the at least one third fluid path for a heat exchange fluid, and the at least one third fluid path is arranged so that the heat exchange fluid can control the control the temperature of the fuel cell board and/or to control the temperature of at least one of the adjacent fuel cell boards, preferably the heat exchange fluid can control the temperature of at least one anode of the adjacent fuel cell board.

5. The fuel cell of claim 1, wherein the at least one third fluid path is on the opposite face of the insulating layer to the at least one first fluid path or the at least one second fluid path on the same insulating layer, preferably so there is no overlap in fluid path through the insulating layer of the at least one third fluid path with the path of the at least one first fluid path or the at least one second fluid path on the same insulating layer.

6. The fuel cell of claim 2, wherein when the first insulating layer comprises the at least one third fluid path for a heat exchange fluid, the sum of the depth of:
i) the at least one first fluid path; and
ii) the third fluid path,
is equal to or greater than the thickness of the first insulating layer; and/or
wherein when the second insulating layer comprises the at least one third fluid path for a heat exchange fluid, the sum of the depth of:
i) the at least one second fluid path; and
ii) the third fluid path,
is equal to or greater than the thickness of the second insulating layer.

7. The fuel cell of claim 1, wherein when the first insulating layer comprises the at least one third fluid path, the depth of the at least one third fluid path is equal to or greater than to the thickness of the first insulating layer; and/or
wherein when the second insulating layer comprises the at least one third fluid path, the depth of the at least one third fluid path is equal to the thickness of the second insulating layer.

8. The fuel cell of claim 7, wherein when the first insulating layer further comprises the at least one third fluid path, the depth of the at least one first fluid path is also equal to or greater than the thickness of the first insulating layer; and/or
wherein when the second insulating layer further comprises the at least one third fluid path, or also comprises at least one heat exchange fluid path, the depth of the at least one second fluid path is also equal to or greater than the thickness of the second insulating layer.

9. The fuel cell of claim 1, wherein the first insulating layer comprises a copper layer on the opposite side of the first insulating layer to the side facing the cathodes, optionally wherein the first insulating layer also comprises a passivation layer on the copper layer, wherein the at least one third fluid path is in the copper and/or in the passivation layer on the first insulating layer; and/or
wherein the second insulating layer comprises a copper layer on the opposite side of the second insulating layer to the side facing the anodes, optionally wherein the second insulating layer also comprises a passivation layer on the copper layer, wherein the at least one third fluid path is in the copper and/or in the passivation layer on the second insulating layer.

10. The fuel cell of claim 9, wherein the fuel cell comprises a plurality of the at least one fuel cell boards, wherein at least two of the plurality of fuel cell boards are arranged so that at least one heat exchange fluid path is between two adjacent fuel cell boards when aligned with each other,
wherein the at least one third fluid path in the copper and/or in the passivation layer on an insulating layer of one fuel cell board and the at least one third fluid path in the copper and/or in the passivation layer on an insulating layer of another adjacent fuel cell board align with each other so as to form the at least one heat exchange fluid path between the two adjacent fuel cell boards.

11. The fuel cell of claim 1, wherein the fuel cell board comprises at least one third insulating layer, and:
i) wherein the first insulating layer comprises the third fluid path and the third insulating layer is located on or adjacent to the face of the first insulating layer which comprises the third fluid path so as to seal the at least one third fluid path, optionally wherein the depth of the first fluid path is equal to or greater than the thickness of the first insulating layer and the third insulating layer also seals the side of the at least one first fluid path not adjacent the cathodes, and/or
ii) wherein the second insulating layer comprises the third fluid path and the third insulating layer is located on or adjacent to the face of the second insulating layer which comprises the third fluid path so as to seal the at least one third fluid path, optionally wherein the depth of the second fluid path is equal to or greater than the thickness of the second insulating layer and the third insulating layer also seals the side of the at least one second fluid path not adjacent the anodes, and/or
iii) wherein the depth of the first fluid path is equal to or greater than the thickness of the first insulating layer, or the depth of the second fluid path is equal to or greater than the thickness of the second insulating layer, the third insulating layer seals the side of the first fluid path not facing the cathodes and/or seals the side of the second fluid path not facing the anodes, and/or
iv) wherein the depth of the first fluid path is equal to or greater than the thickness of the first insulating layer, and the depth of the second fluid path is equal to or greater than the thickness of the second insulating layer, the third insulating layer seals the side of the first fluid path not facing the cathodes or seals the side of the second fluid path not facing the anodes and a further/fourth insulating layer seals the side of the first fluid path not facing the cathodes or seals the side of the second fluid path not facing the anodes, optionally wherein the at least one third insulating layer or the fourth insulating layer is thinner than the first insulating layer or the second insulating layer.

12. The fuel cell of claim 11, wherein iii) and/or iv) further comprises a third insulating layer and/or a fourth insulating layer comprising a copper layer on the opposite side of the third or fourth insulating layer to the side sealing first and/or second fluid path, optionally wherein the first insulating layer also comprises a passivation layer on the copper layer,
wherein the at least one third fluid path is in the copper and/or in the passivation layer on the third insulating layer.

13. The fuel cell of claim 12, wherein the fuel cell comprises a plurality of the at least one fuel cell boards, wherein at least two of the plurality of fuel cell boards are arranged so that at least one heat exchange fluid path is formed between two adjacent fuel cell boards when aligned with each other,
wherein the at least one third fluid path in the copper and/or in the passivation layer on the third or fourth insulating layer of one fuel cell board and the at least one third fluid path in the copper and/or in the passivation layer on the third or fourth insulating layer of another adjacent fuel cell board align with each other so as to form a combined heat exchange fluid path between the two fuel cell boards.

14. The fuel cell of claim 11, wherein in iii) or iv) the third insulating layer and/or the further/fourth insulating layer comprise the at least one third fluid path for a heat exchange fluid, optionally wherein the depth of the at least one third fluid path for a heat exchange fluid is equal to or greater than the thickness of the third and/or fourth insulating layer.

15. The fuel cell of claim 1, wherein the fuel cell board comprises multiple first fluid paths and/or multiple second fluid paths and/or multiple third fluid paths, or
wherein the at least one third fluid path has a different flow path pattern or flow field to the at least one first fluid path or the at least one second fluid path, or
wherein one or more of the insulating layers comprise one or more PCB layers, or
wherein at least one of the first insulating layer, the second insulating layer and/or the third insulating layer comprises one or more means to conduct electrical current from one face of that insulating layer to the other face of that insulating layer, preferably wherein the means to conduct electrical current are plated through holes, preferably copper plated through holes.

16.-18. (canceled)

19. The fuel cell of claim 1, wherein the heat exchange fluid comprises water or a mixture of water and glycol, or
wherein one or more of the insulating layers are laminated together or mechanically pressed or compressed together in the fuel cell, or
wherein the oxidant fluid is air and/or the reductant fluid is hydrogen gas, or
wherein the fuel cell board has a power rating of between 10 W and 1000 W, and/or the fuel cell has a power rating of between 10 kW and 1000 kW.

20.-23. (canceled)

24. A component for an electrochemical device, the component comprising an insulating layer comprising at least one first fluid path on one face of the insulating layer and a second fluid path for a heat exchange fluid on the opposite face of the insulating layer.

25. The component of claim 24, wherein the second fluid path is arranged on the opposite face of the insulating layer so there is no overlap in fluid path through the insulating layer of the at least one second path with the first fluid path, or
wherein the sum of: i) the depth of the at least one first fluid path and ii) the depth of the second fluid path is equal to or greater than the thickness of the insulating layer, or
wherein the component comprises a second insulating layer, wherein the second insulating layer is located on or adjacent to the face of the insulating layer which comprises the second fluid path so as to seal the second fluid path, optionally wherein the second insulating layer is thinner than the insulating layer.

26.-27. (canceled)

28. The component of claim 24, wherein the insulating layer comprises a copper layer on the opposite side of the first insulating layer to the first fluid path, optionally the first insulating layer also comprises a passivation layer on the copper layer, wherein the second fluid path is in the copper and/or in the passivation layer.

29. The component of claim 24, wherein one or more of the insulating layers comprise one or more PCB layers.
